(19) United States
(12) Patent Application Publication
(10) Pub. No.: US 2025/0028694 A1
(43) Pub. Date: Jan. 23, 2025

(54) RANGING TECHNIQUES FOR EFFICIENT CLEANING OF UNNEEDED ROW-VERSIONS OF A DATABASE

(71) Applicant: Regatta Data Ltd., Bet Hanania (IL)

(72) Inventors: Irit YADIN-LEMPEL, Caesarea (IL); Erez WEBMAN, Petach Tikva (IL)

(73) Assignee: Regatta Data Ltd., Bet Hanania (IL)

(21) Appl. No.: 18/774,538

(22) Filed: Jul. 16, 2024

Related U.S. Application Data
(60) Provisional application No. 63/515,302, filed on Jul. 24, 2023.
(60) Provisional application No. 63/514,690, filed on Jul. 20, 2023.

(51) Int. Cl. G06F 16/215

(52) U.S. Cl. CPC G06F 16/215

(57) ABSTRACT

In one general aspect, a method may include selecting eligible row-versions for inspection. The method may also include inspecting the selected row-versions, where the inspection results in a classification of eligible row-versions as unneeded or reliant. The method may furthermore include marking row-versions classified as unneeded as approved for immediate removal. The method may, in addition, include adding row-versions classified as reliant on cleaner structures. The method may moreover include upon detection of removal of all point-in-times (PiTs) related to a reliant row-version, deleting the reliant row-version, where the detection is performed by monitoring the cleaner structures. Other embodiments of this aspect include corresponding computer systems, apparatus, and computer programs recorded on one or more computer storage devices, each configured to perform the actions of the methods.

### CROSS-REFERENCE TO RELATED APPLICATIONS

This application claims the benefit of U.S. Provisional Application No. 63/514,690 filed on Jul. 20, 2023, and the benefit of U.S. Provisional Application No. 63/515,302 filed on Jul. 24, 2023. This application also relates to U.S. patent application Ser. No. 18/641,856, filed on Apr. 22, 2024. The contents of which are hereby incorporated by reference.

### TECHNICAL FIELD

The present disclosure generally relates to databases, and specifically, techniques for implementation for efficient cleaning of unneeded row-versions of databases.

### BACKGROUND

In databases, concurrency control (CC) protocols ensure that correct results for concurrent operations are generated as quickly as possible. Typically, a concurrency control protocol provides rules and methods typically applied by the database mechanisms to maintain the consistency of transactions operating concurrently and, thus, the consistency and correctness of the whole database. Introducing concurrency control into a database would apply operation constraints which typically result in some performance reduction. Operation consistency and correctness should be achieved with as good as possible efficiency without reducing the database's performance. However, a concurrency control protocol can require significant additional complexity and overhead in a concurrent algorithm compared to the simple sequential execution of the transaction.

Databases are designed with Atomicity, Consistency, Isolation, and Durability (ACID) requirements. In some databases, the ACID requirements are relaxed, where multiple transactions can be executed concurrently and independently of each other, such that transaction access overlaps. That may result in various inconsistencies or anomalies. A database can be designed to provide ACID guarantees that eliminate or minimize the exposure of such anomalies. In general, there are varying degrees of ACID guarantees, and many databases provide a non-perfect degree of ACID guarantees, where the exact guarantees vary among the different database products.

Typically, such guarantees are defined by the isolation level of their transaction execution. An isolation level expresses how transactions are “isolated” from each other, especially related to their data-cell read and write activities. That is, isolation of transactions means how the anomalies can be mitigated or completely avoided. The strongest transaction isolation level is serializable. In this isolation level, the database provides mechanisms guaranteeing the isolation for the concurrent execution of transactions while maximizing the concurrency of the execution transactions as much as possible.

An approach, often used for relaxed isolation-level guarantees, as performed by some traditional relational databases, is based on creating a “frozen” point-in-time image (hereafter PiT Image, or simply a PiT or PiTs) for a transaction. The PIT provides the state and the content of the committed data and allows the reader of the data cell based on the values of a PiT.

Various techniques for creating, maintaining, and removing PiTs are discussed in the related art. However, these techniques are mostly limited to creating, maintaining, and removing PiTs in a non-distributed database. A distributed database includes multiple nodes (typically, a node is a computer) where the nodes may be situated in the same physical location or in multiple locations.

Creating, maintaining, and removing PiTs in a distributed database provides a number of challenges that are not efficiently addressed by currently available PiT solutions. For example, creating a PiT in a distributed environment requires that the point-in-time of the frozen “transaction” be consistent across all the nodes of the database. Further, current solutions are not scalable enough, not fast enough, and slow down other activities in a non-linearly scalable fashion, thereby such a solution does not allow a very high-rate PiT creation, especially in clusters with a large number of nodes.

In the context of databases and data management, “row-versioning” typically refers to a mechanism that maintains a historical version of each row in a table to manage concurrency and to provide the ability to restore or read previous versions. Row versioning is a database management technique used to maintain different versions of the same row at the same time. For example, if a row is modified after a Point-in-Time (PiT) is created, the database needs to maintain both the original and modified versions of the row. Similarly, if a row is updated during a transaction, some databases keep the updated version as an uncommitted row version until the transaction commits alongside the original row version.

In order to create PiTs, specific data structures, such as row-versions, need to be generated. However, some of these data structures may become not required on certain occasions, for example, once a transaction is committed, or when certain PiTs are removed, and so on. The removal of such not-required data structures is essential for the efficient operation of the database. Removing these structures is not as simple because such structures may be needed by a possibly different set of multiple PiTs. Thus, determining when each such structure is no longer required is not a simple task. There are various techniques available to clean up unneeded row versions of a database, but most of them are resource-intensive and time-consuming, which can limit performance. For example, a technique, such as PostgreSQL's Vacuum cleaning, requires crawling the database rows. This technique is costly both in terms of performance and resource usage. The above-mentioned difficulties are relevant to both distributed and non-distributed databases.

It would therefore be advantageous to provide efficient solutions for efficiently removing unneeded data structures in distributed and non-distributed databases.

### SUMMARY

A system of one or more computers can be configured to perform particular operations or actions by virtue of having software, firmware, hardware, or a combination of them installed on the system that, in operation, causes or causes the system to perform the actions. One or more computer programs can be configured to perform particular operations or actions by virtue of including instructions that, when executed by a data processing apparatus, cause the apparatus to perform the actions.

In one general aspect, a method may include selecting eligible row-versions for inspection. The method may also include inspecting the selected row-versions, where the inspection results in a classification of eligible row-versions as unneeded or reliant. The method may furthermore include marking row-versions classified as unneeded as approved for immediate removal. The method may in addition include adding row-versions classified as reliant to cleaner structures. The method may moreover include upon detection of removal of all point-in-times (PiTs) related to a reliant row-version, deleting the reliant row-version, where the detection is performed by monitoring the cleaner structures. Other embodiments of this aspect include corresponding computer systems, apparatus, and computer programs recorded on one or more computer storage devices, each configured to perform the actions of the methods.

In one general aspect, a device may include one or more processors configured to: select eligible row-versions for inspection; inspect the selected row-versions, where the inspection results in a classification of eligible row-versions as unneeded or reliant; mark row-versions classified as unneeded as approved for immediate removal; add row-versions classified as reliant to cleaner structures; and upon detection of removal of all point-in-times (PiTs) related to a reliant row-version, delete the reliant row-version, where the detection is performed by monitoring the cleaner structures. Other embodiments of this aspect include corresponding computer systems, apparatus, and computer programs recorded on one or more computer storage devices, each configured to perform the actions of the methods.

In one general aspect, non-transitory computer-readable medium may include one or more instructions that, when executed by one or more processors of a device, cause the device to: select eligible row-versions for inspection; inspect the selected row-versions, where the inspection results in a classification of eligible row-versions as unneeded or reliant; mark row-versions classified as unneeded as approved for immediate removal; add row-versions classified as reliant to cleaner structures; and upon detection of removal of all point-in-times (PiTs) related to a reliant row-version, delete the reliant row-version, where the detection is performed by monitoring the cleaner structures. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram of a distributed computing environment utilized to describe the various disclosed embodiments.

FIG. 2 shows an example diagram of database arranged according to an embodiment.

FIG. 3 shows an example flowchart of a method for executing a transaction directed to the database according to an embodiment.

FIG. 4 is an example timeline demonstrating scenarios where the disclosed Interval-Based-Cleaning-Technique (IBC-technique) is applicable.

FIG. 5 is an example of a flowchart for cleaning row-versions according to the disclosed embodiments.

FIG. 6 is an example of a flowchart illustrating the operation for inspecting row-versions according to the disclosed embodiments.

FIG. 7 shows an example diagram of the inspection of four row-versions.

FIGS. 8A and 8B shows an example diagram of an inspection where a row, R1, is modified twice before the modifications are inspected.

FIG. 9 shows an example diagram of an inspection where a row, R2, is modified four times before the modifications are inspected.

FIG. 10 shows an example diagram of a similar scenario to that of FIG. 9, where a row, R2, is modified four times before the modifications are inspected, which results in the row-versions V21, V22, V23, and V24.

FIGS. 11A-11D show an example diagram demonstrating the properties of PINTs, Open-Ended PINTs, PiT-empty PINTs, and PINT collections.

FIGS. 12A-12D show an example diagram demonstrating the dynamics of a fixed-rough-intervals strategy using RTINTs.

FIG. 13 is an example diagram demonstrating how RTINTs may be configured in an N-level PINT strategy in an embodiment.

FIG. 14 is an example diagram that demonstrates a PRNG structure according to an embodiment.

FIGS. 15A-15D illustrate some examples showing the identification of a tightest PRNG for a row-version according to the embodiment.

FIGS. 16A-16C show an example diagram demonstrating the PRNG expansion principle.

FIG. 17 illustrates an example diagram of the organization of PRNG objects in PRNG collections.

FIGS. 18A through 18F are example diagrams demonstrating the procedure when a PINT becomes PiT-empty.

FIG. 19 shows an example flowchart of a procedure for identifying PINTs and locating the pertinent PRNG collection to add classified reliant row-versions according to an embodiment.

FIGS. 20A-20B demonstrate PINTSs removal.

FIG. 21 shows an example flowchart for removing a PINT according to an embodiment.

FIGS. 22A and 22B demonstrate the result for removing a PINT.

FIGS. 23A-23B demonstrates the merging of PRNG collections according to an embodiment operation.

FIG. 24 is an example schematic diagram of a hardware layer of a node in a database according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, numerals refer to like parts through several views.

Some example embodiments provide a system and method for efficiently and timely cleaning row-versions in a distributed or a non-distributed database. The disclosed embodiments provide a solution for a total cleaning of row-versions. This is performed not by scanning the entire set of row-versions but rather through a deduction of when a specific row-version can be removed. As will be discussed below, the disclosed techniques define two types of row-versions that can be cleaned: unneeded and reliant, where the former can be removed immediately (without waiting for a PiT removal), and the latter can be removed when its respective PiT(s) are removed, as a result of which the reliant row-version become unneeded and can then be cleaned.

Generally, the cleaning of unneeded row versions is often managed by each of the nodes in a distributed database or on a node of a non-distributed database that has stored unneeded row versions thereon.

It should be noted that the embodiments described herein are not limited to database systems but are also applicable to distributed data management systems, such as an object storage system, a key-value storage system, a file system, and the like.

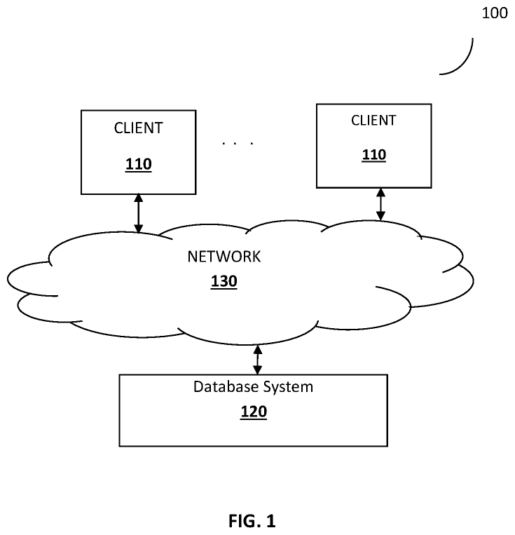

FIG. 1 shows an example network diagram 100 of a distributed computing environment utilized to describe the various disclosed embodiments. In the example network diagram 100, a plurality of clients 110 and a database system (or simply database) 120 are connected to a network 130. Database 120 can be either distributed or non-distributed database. The network 130 may be but is not limited to, wireless, cellular, or wired network, a local area network (LAN), a wide area network (WAN), a metro area network (MAN), the Internet, the Worldwide web (WWW), similar networks, and any combination thereof.

Each client 110 is configured to access the database 120 through the execution of transactions. A client 110 may include any computing device executing applications, services, processes, and so on. A client 110 can run a virtual instance (e.g., a virtual machine, a software container, and the like).

In some configurations, clients 110 may be software entities that interact with the database 120. Clients 110 are typically located in compute nodes that are separate from the database 120 and communicate with the database 120 via an interconnect or over a network. In some configurations, an instance of a client 110 can reside in a node that is part of the database 120.

The database 120 may be designed according to a shared-nothing or a shared-everything architecture. In one example embodiment, transactions to the database 120 are processed without locks placed on data entries in the database 120. This allows for fast processing retrieval and modifications of data sets.

A transaction is issued by a client 110, processed by the database 120, and the results are returned to the client 110. A transaction typically includes the execution of various data-related operations over the database system 120. These operations often originate from clients 110. The execution of such operations may be short or lengthier. In many cases, operations may be independent and unaware of each other's progress.

A transaction can be viewed as an algorithmic program logic that potentially involves reading and writing various data-cells. A transaction, for example, may read some data-cells through one data operation, and then, based on the values read, can decide to modify other data-cells. That is, a transaction is not just an “I/O operation” but is more of a “true” computer program. A data-cell is one cell of data. Data cells may be organized and stored in various formats and ways. Data cells, defined below, may be contained in files or other containers and can represent different types of data (integer, string, and so on).

In one embodiment, an execution of a transaction may be shared between a client and the database 120. For instance, in an SQL-based relational database, client 110 interacts with the database using SQL statements. Client 110 can begin a transaction by submitting an SQL statement. That SQL statement is executed by database 120. Depending on the exact SQL statement, database 120 performs various read and/or write operations as well as invokes algorithmic program logic typically to determine which (and whether) data-cells are read and/or written. Once that SQL statement is completed, the transaction is generally still in progress.

The client 110 is configured to receive the response for that SQL statement and potentially executes some algorithmic program logic (inside the client node) that may be based on the results of the previous SQL commands, and as a result of that additional program logic, may submit an additional SQL statement and so forth. At a certain point, and once the client 110 receives an SQL statement response, the client 110 can instruct the database 120 to commit the transaction.

It should be noted that the client 110 can submit a transaction as a whole to the database 120, and/or submit multiple statements for the same transaction together, and/or submit a statement to the database 120 with an indication for the database to commit after the database 120 completes the execution of that statement.

It should be further noted that transactions may be abortable by the database 120 and/or a client 110. Often, aborting a transaction clears any of the transaction's activities.

For the sake of simplicity and ease of description, a reference is made to a transaction initiated and committed by a client, and statements of the transaction are performed by the database 120. A transaction may include one or more statements. A statement may include, for example, an SQL statement. One of the statements may include a request to commit the transaction. In order to execute such a statement, the database may break the statement execution into one or more tasks, where each such task is running on a node. In this particular embodiment, a task does not execute on more than a single node, but multiple tasks of the same statement can execute on the same node if needed. A task is an algorithmic process that may require the execution of read operation(s) and/or write operations(s) on data cells.

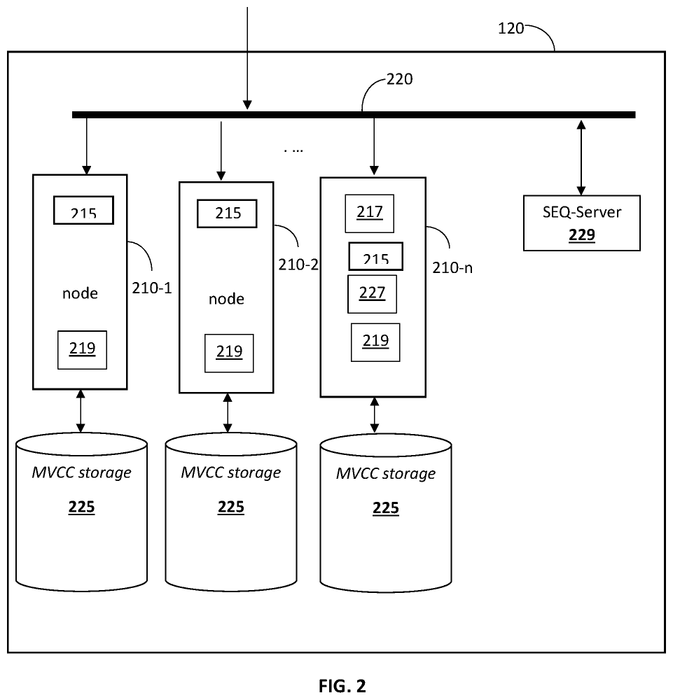

In an embodiment, the database 120 is a distributed database and may be realized as a relational database system (RDBMS) or a non-relational database. As will be demonstrated in FIG. 2 below, a distributed database is a configuration of multiple nodes that may be situated in the same physical location or in multiple locations. Such locations are typically not geographically distributed. In some embodiments, the distribution arrangement of database 120 requires the execution of transactions and their operations on different nodes independent of each other. Typically, a node is a computer, however, it can also be a virtual server, a user-mode process, a combination thereof, and the like.

In another embodiment, the database 120 is a non-distributed database and may be realized as a relational database system (RDBMS) or a non-relational database. A non-distributed database is a configuration of one node that may be situated in one physical location. Also, in a non-distributed database, a node is generally a computer. However, it can also be a virtual server, a user-mode process, a combination thereof, or the like.

FIG. 2 shows an example diagram of database 120 arranged according to an embodiment. The database 120 includes a plurality of nodes 210-1 through 210-n, which are distributed. Each node 210 may be realized as a physical device or a virtual instance executed on a physical device. A virtual device may include a virtual machine, a software container, a service, and the like. The physical device, an example of which is disclosed below, includes at least a processing circuitry and a memory. A physical device may also include a storage, a shared storage accessed by other nodes 210, or a combination thereof. The storage stores the data maintained by the database 120. The nodes 210 may be deployed in one or more data centers, cloud computing platforms, and the like. The communication and synchronization among the nodes 210 is performed through an interconnect network 220.

In one embodiment, the nodes 210 and hence the database 120 are designed with a shared-nothing architecture. In such an architecture, nodes 210 are independent and self-sufficient as they have their own disk space and memory. As such, in the database 120, the data is split into smaller sets distributed across the nodes 210. In another embodiment, the nodes 210, and hence, the database 120 are designed with a shared-everything architecture where the storage is shared among all nodes 210.

The data managed by the database can be viewed as a set of data-cells. Typically, data-cells would be considered as items, such as what relational databases refer to as “column cells,” those data-cells can actually be any type of data, a data object, a file, and the like.

Databases often organize a higher level of a data-cell referred to as a data-row (or simply row). A data-row may include a collection of specific data-cells. For example, in relational databases, a set of rows form a database table. The data-cells contained by a specific row are often related to one “entity” that the row describes. In relational databases, the concept of a data-row is inherent to the data-model (i.e., one of the foundations of the relational data-model is processing “data tuples” that are effectively data-rows). Often, data-cells can be added or removed only as part of their data-row. In other words, a data-row can be added (or removed), thus adding more (or removing existing) data-cells to the database.

Typically, all the data-cells of a specific row reside in close proximity (e.g., consecutively) on the storage device (as well as in RAM), as this can ensure that multiple cells of the same row (or all the cells of the row) can be read from the disk more cheaply (e.g., with a single small disk I/O) than if those cells would each be stored elsewhere on the disk (e.g., with n disk I/Os to n different disk locations in order to retrieve n cells of the same row). Further, the metadata for managing the data-cell information may also be organized in a rougher resolution as it may result in meaningfully lesser and smaller overall metadata.

In some embodiments, a specific data-row can be viewed as if it exists and just contains a single specific data-cell. In one embodiment, and without limiting the scope of the disclosed embodiments, a single cell and a single row may reside in a specific storage device of node 210. However, it should be noted that a row can be divided across multiple nodes 210. It should be further noted that the disclosed embodiments can be adapted to operate in databases where data cells are stored and arranged in different structures. In some embodiments, where a row is divided across multiple nodes, the “sub row” that is stored under a single node and/or storage device could be treated as a data-row.

In another embodiment, and without limiting the scope of the disclosed embodiments, the database may also store various pieces of data, in addition to the data-cells and data-rows, including, but not limited to, any and all metadata, various data structures, configuration information, a combination thereof, and the like (hereinafter “metadata”).

In some embodiments, an operation of a task may access a single data-cell in a single node 210. Furthermore, multiple operations (of the same or different transactions) may access the same data cells simultaneously or substantially at the same time. In these embodiments, there is no synchronization when such operations, tasks, or statements of a transaction or transactions are performed. In a typical computing environment, hundreds of concurrent transactions can access the database 120. As such, maintaining and controlling the consistency of transactions and their operations is a critical issue to resolve in databases.

In an embodiment, each node 210 includes an agent (or a transaction agent) 215 configured to manage access to data stored on the respective node. The agent 215 may be realized in hardware, software, firmware, or a combination thereof. Software shall be construed broadly to mean any type of instructions, whether referred to as software, firmware, middleware, microcode, hardware description language, or otherwise. Instructions may include code (e.g., in source code format, binary code format, executable code format, or any other suitable format of code).

The agent 215 is configured to manage the contents of data cells and operations within a node. For example, when a write operation requires access to data-cell(s), the agent 215 may be configured to point to the requested cell(s). In an embodiment, each transaction is managed by a transaction manager 217. A transaction manager 217 is an instance executed over one of the nodes 210 and configured to orchestrate the execution of a transaction across one or more nodes 210. The transaction manager 217 may be instantiated on any node 210.

In the example shown in FIG. 2, the transaction manager 217 is configured to be executed on the node 210-n. The transaction manager 217 can be realized as a software object, a script, and the like executed over the hardware of a respective node 210. It should be noted that multiple transaction managers may be executed on one node or multiple nodes, where each transaction manager 217 can handle a single transaction.

In one example configuration, the database 120 contains a SEQ-server 229, running on one of the nodes 210. Other configurations that do not require an SEQ-server are discussed below. A sequence server (SEQ-server) 229 can be viewed as a software module. In some embodiments, the SEQ-server 229 is configured to dynamically move to another node 210 for various practical needs, such as, but not limited to, the need to provide high availability and fault-tolerance, the need to balance the overall load of the cluster, the need to remove the node that the SEQ-server 229 is currently on, a combination thereof, and the like. In one embodiment, the SEQ-server 229 is statically located. In another embodiment, the SEQ-server 229 is configured to be moved.

According to one configuration, the SEQ-server 229 is configured to run on a dedicated node 210, in one of the nodes 210, outside of a node 210.

According to the disclosed embodiments, the SEQ-server 229 is configured to execute processes for the creation of point-in-time images (hereinafter “PiT” or “PiTs”). The SEQ server is also responsible for allocating commitment timestamps (CMTSs). A PiT is the current state (or contents) of the data maintained by the database system 120 of the committed data for a given timestamp. A PiT is typically created at the beginning of the transaction (or during the execution of a transaction) upon request initiated by a transaction manager. It should be noted that the creation of PiTs with minimal communication between transaction managers and the SEQ-Server 229 and without any need to synchronize the creation of PiTs among other nodes 210.

In an embodiment, the SEQ-server 229 is configured to include or implement a logical timestamp counter (LTC). The LTC is incremented (or increased) upon creation of a PiT. It should be noted that the LTC can be realized as an integer counter, a timer, a register, and the like, or any monotonically increasing counter. Further, the LTC can be incremented by one or increased by any arbitrary number. The LTC's value is treated as a PiT creation timestamp. It should be emphasized that there is a single LTC in the SEQ-server 229 that provides the timestamp for PiT or CMTS.

According to the various disclosed embodiments, a sequencer agent (SEQ-agent) 219 is a software entity. In some embodiments, SEQ-agents 219 are located in various database nodes 210. The SEQ-agent 219 is configured to communicate with the SEQ-server 229 and provide various services to a respective node. In one configuration, the SEQ-agents 219 are located inside of each node. In another configuration, the SEQ-agents 219 may be separate from the node and be located in different areas such as, but not limited to, a different node 210 than the node using the services of the SEQ-agent 219. In some embodiments, the SEQ-agent 219 is configured to provide services to multiple nodes.

In some configurations including distributed and non-distributed databases, the arrangement shown in FIG. 2 does not include the SEQ-server 229. In such configurations, the functionality of SEQ-server 229, or parts of the functionality of SEQ-server 229, such as the creation of PiTs, the removal of PiTs, the determination of the PiT timestamp, the propagation of the PiT creation and/or removal to other nodes, and so forth, is performed by possibly alternative mechanisms that may reside in a specific node or set of nodes, at each node or by a cleaning engine 227.

In some embodiments, in order to create the PiT and retrieve its timestamp in a non-distributed database, a database node may employ various techniques to generate the timestamp. For instance, the node could increment an LTC and use its value as the PIT creation timestamp provided to the transaction manager.

In an embodiment, to create the PiT and retrieve its timestamp in a distributed database that does not use SEQ-server, the database can use any alternative timestamp mechanism to allocate the logical (or real) timestamp of the PIT. For example, a timestamp mechanism may be implemented as a non-distributed logic or as a distributed logic. Such a mechanism may use various techniques to provide the expected timestamp semantics, such as counters, clock synchronization, and the like. The creation of PiT may involve techniques such as distributed barriers, or other techniques to achieve PiT consistency.

The Multi-Version Concurrency-Control (MVCC) storage 225 is a persistent storage or memory configured to store data. Further, in some embodiments, the MVCC can be realized as a data-layout on a physical or virtual disk. According to an embodiment, node 210 is responsible for specific data-cells and data-rows. Each node has access to MVCC storage 225 that allows read and write operations based on the MVCC data-layout configured with the MVCC storage 225. It should be noted that, in some embodiments, the database 120 may contain stateless compute nodes whose main functionality is to participate in various computations the database performs. Such nodes may not necessarily contain the MVCC data layout.

In some embodiments, the structure of the Multi-Version Concurrency-Control (MVCC) data-layout is a persistent data-layout that allows multi-version data-cells in the MVCC storage 225, regardless of whether the CC-protocol in use directly exploits multi-version data-cells or not. Typically, databases need the ability to store multiple data-cell versions for various reasons, including for PiT maintenance and for storing uncommitted data-cell versions as well as temporarily storing both uncommitted versions, committed versions, uncommitted versions that just recently became committed versions, committed versions that just recently became not-up-to-date versions (and may soon be removed), and so on.

In such cases, there is a need for persistent (and sometimes also non-persistent) data-layouts that allow the maintenance of multiple versions. Such data-layouts allow various “write” operations, such as, for example, the insertion of new data-cells, the insertion of new data-cell versions, the modification of existing data-cell versions, the removal of data-cell versions or of the entire data-cell, etc. Further, databases typically store all the data-cells of a data-row together rather than storing each data-cell separately. Therefore, MVCC data-layouts often store data-rows and data-row-versions rather than data-cell and data-cell versions. If a specific data-cell has a new version, such MVCC data-layouts store a new version of the entire row.

In databases, “row-versioning” typically refers to a mechanism that maintains a historical version of each row in a table to manage concurrency and to provide the ability to restore or read previous versions. Row versioning is a database management technique used to maintain different versions of the same row at the same time. For example, if a row is modified after a PiT is created, the database needs to maintain both the original and modified versions of the row. Similarly, if a row is updated during a transaction, some databases keep the updated version as an uncommitted row version until the transaction commits alongside the original row-version.

In an embodiment discussed herein, the MVCC data-layout uses a row granularity, where versioning is managed using row-versions and where a data-row can be added or removed. It should be noted that MVCC data-layouts that use different (finer or rougher) granularities, such as data-cell granularity can be used as well. Further, embodiments where the data-cells can be added and/or removed are supported as well.

The MVCC data-layout also provides a means for searching and reading specific row-versions (or any subset of their data-cells). For example, searching and reading a specific row can be done by using any specific row identification technique the database is internally using. The second aspect is the need to reach the desired version of the row, where it is not always known ahead of time which version that would be. In many cases, this task is achieved by performing searches that refer to the timestamps of the existing versions of the row, and/or by traveling between versions of the same row by their timestamp (possibly in either direction).

It should be noted that the timestamp information can be considered part of the metadata used for the realization of the MVCC data-layout. In some embodiments, the MVCC data-layout utilizes the commitment timestamp (CMTS) as the timestamp used by the various read operations, and that MVCC data-layout is used also for storing uncommitted row-versions. In such embodiments, when a new row-version (e.g., for an existing row) is first created and is still in an uncommitted state, the CMTS is generally not yet known. This problem can be solved in a variety of approaches. It should be emphasized that the disclosed embodiments can be adapted to support any type of storage with any type of layout.

In an embodiment, each MVCC storage 225 includes a cleaning engine 227. The client engine 227 executes the row-version cleaning techniques disclosed according to the various embodiments. A cleaning engine 227 carries the cleaning techniques locally within a node or across a number of nodes 210. For example, suppose the distributed database contains 100 nodes, N₁, . . . , N₁₀₀, where N₁ . . . , N₉₀ contain an MVCC storage 225 that may require cleaning. In this example, each node contains a cleaning engine 227 running cleaning techniques. However, the mechanisms of the cleaning techniques are mainly local to each specific cleaning engine 227.

It should be noted that the disclosed embodiments are also applicable for a non-distributed database. In such an arrangement, the database 120 includes only one node, e.g., node 210-1 and its corresponding MVCC storage 225 and cleaning engine 227. In a non-distributed database there is no need for a SEQ-Server.

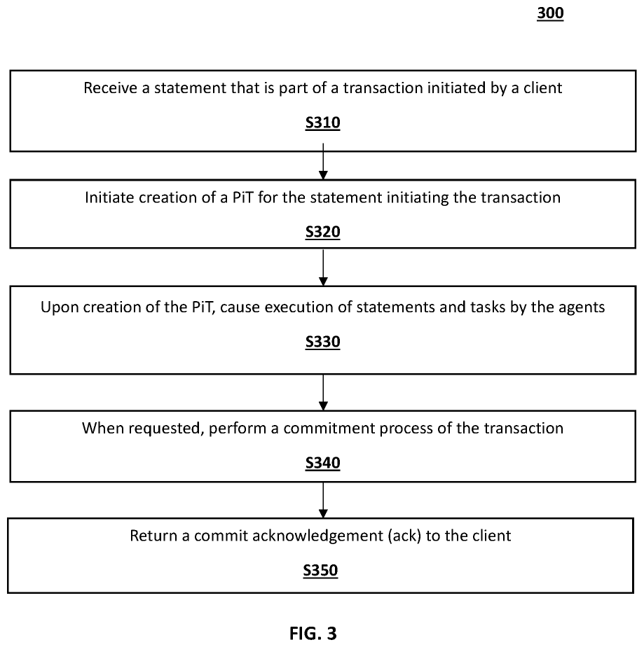

FIG. 3 shows an example flowchart 300 of a method for executing a transaction directed to the transaction database 120 according to an embodiment. The method can be performed by a transaction manager instantiated on one of the nodes, such nodes as 210, FIG. 2. It should be noted that FIG. 3 is an example that discusses the creation of a point-in-time image (PiT) at the beginning of the transaction. However, such creation of a PiT could occur at any and all stages of a transaction. Alternatively or collectively, a PiT may be created per statement received from a client to be executed over the database 120 or upon reception of a number of statements. It should be noted that the decision when to request and/or create a PiT may be based on the execution requirements of the transaction, required isolation-mode, and the like.

At S310, at least one statement that is part of a transaction initiated by a client is received. As mentioned above, a transaction may include a collection of statements, each of which may include a collection of tasks. A task may require the execution of read operation(s), write operation(s), or both. A statement may include a commit statement thereby committing the transaction.

It should be noted that the transaction manager resides or operates at node 210-1 to which a client sends statements of a transaction (TR1). Alternatively, the transaction manager for a transaction (TR1) may be set to run on another node 210-n. In such configuration, the node 210-1 may propagate the statements to the node 210-n. In this example embodiment, the transaction manager can manage a specific transaction (e.g., TR1). Other transaction managers manage other concurrently executed transactions. Typically, but not limited to, such transaction managers are spread across the cluster of nodes 210.

At S320, the creation of a point-in-time image (PiT) is initiated. In an embodiment, S320 occurs by the transaction manager when a PiT-based transaction begins. A PiT-based transaction may be utilized for repeatable-read isolation mode protocols, read-committed protocols, protocols that provide stronger isolation guarantees, specific moments during the transaction execution, a combination thereof, and the like. In an embodiment, an initiation of a PiT may be triggered when an execution of a task begins.

In an embodiment, to create the PIT, a PiT creation request is sent to the SEQ-agent. The SEQ-agent is configured to send such messages to the SEQ-server for the creation of the PIT. The SEQ-server is configured to increment the LTC where its value is returned as PiT creation timestamps by the SEQ-server to the SEQ-agent, and then from the SEQ-agent to the transaction manager.

In some example configurations, the SEQ-server is configured to asynchronously stream information about PiTs to all the nodes, for example, in order to remove unneeded row-versions. In other configurations, other mechanisms, such as those discussed above, can be utilized in a distributed or non-distributed database to replace the functionality of the SEQ-server. It should be emphasized that the SEQ-server is not always required to perform the row-versions cleaning embodiments discussed herein.

In some instances, it is desired to reduce the number of PiTs taken. Therefore, according to the disclosed embodiments, a single PiT (hereinafter a “Unified PiT”) is created to be utilized by multiple different transactions.

It should be noted that causing the creation of a PIT at the beginning of a transaction or a statement is merely one example. A PiT can be created at any stage of the execution of the transaction or a statement. Once a PiT is created, an indication that the created PiT is ready is returned by the SEQ-agent 219. The PiT timestamp is also returned.

At S330, upon the reception of an indication that the PiT is ready, execution of statements and/or tasks by the respective transaction agents is initiated. To this end, the timestamp of the PiT is provided to the agents. It should be noted that, in this embodiment, PiT is created in response to a statement initiating the transaction. The PiT, in this embodiment, is not created for each received statement.

According to some embodiments, during S330, execution of read and/or write operations may be performed. In an embodiment, the statements may include but are not limited to, reading a data-cell or data-row (such as, PiT read and current read, etc.), writing to a data-cell or a data-row, modifying a row, and the like. In an embodiment, the execution of a transaction's statements is performed by transaction agents. The executions of read and write operations are discussed in U.S. patent application Ser. No. 18/641,856 referenced above.

In this embodiment, it should be noted that S330 is performed as long as the received statements require execution of a read operation, a write operation, or any operation that is not a commit. Upon receiving a commit statement, execution proceeds to S340. In the context of database transactions, a “commit” refers to the action of permanently saving all the changes made during the current transaction to the database. When a transaction is committed, all the operations within that transaction are made permanent and can be seen by other users and transactions. Until a transaction is committed, its changes are not visible to other users and transactions.

At S340, upon receiving a commit statement from the client, a commit process of the transaction (received at S310) is performed. Execution of the commit process is performed to ensure the ACID properties of the transaction. In an embodiment, during the commit process, the modifying transaction agent is configured to perform the actions necessary to turn its uncommitted row-versions into committed row-versions. Such actions may be performed while a commit pause(s) taken by the modifying transaction agent are still acquired (i.e., prior to the commit pauses release).

It should be noted that typically a transaction is not purely executed inside the database 120. Instead, transaction execution is effectively a shared effort between the client and the underlying database, as the client can submit statements, perform algorithmic logic, and, as a result, submit more statements, all as part of the same transaction. The CC protocols used by the database can be very effective in enforcing how activities are being performed inside the underlying database. It, therefore, can be very effective in making those enforcements for the execution of the statements submitted by the client on behalf of the transaction. However, the database has limited abilities to dictate the behavior of the transaction algorithmic logic running on the client due to external behavior. Such an external behavior can sometimes completely break the level of ACID guarantees provided by the underlying database's CC protocol in use for the transaction.

For example, in a perfectly serializable isolation-level, a client submits a statement that reads some data-cells, and the statement returns those read values to the client, while the transaction is still in progress. If the client communicates those read values outside of the logical scope of the transaction, the client may seriously violate the isolation-level guarantees it tries to achieve with that transaction (as those values must not be relied on at that stage in time prior to the transaction commitment, by anybody else but that specific transaction). Therefore, it is generally expected that the client logic for the transaction will obey some general rules if it expects to achieve the exact isolation-level that is guaranteed by the underlying database's CC-protocol in use for the transaction.

Some database products support multiple different isolation-levels, supported by different CC-protocols (and/or different variations of the same CC-protocol). Furthermore, those databases often allow multiple transactions to run under different isolation-levels simultaneously, even if they access the same tables, rows, cells (or any other relevant data-object). Some databases can support multiple CC-protocols/isolation-levels, where multiple simultaneous transactions could choose their specific isolation-level.

It should be noted that there are cases where a database supports multiple different CC-protocols that all provide more-or-less (or exactly) the same isolation-level-those CC-protocols have different implementations and different performance characteristics. In such cases, the one of ordinary skill may choose the best-fitting CC-protocol for each of his transactions, based, for example, on his knowledge about which CC-protocol will perform best for each of his transactions. For example (and that example is specifically relevant for the disclosed embodiments), in environments that expect fully-serializable execution, it is sometimes better to execute read-only transactions using a PiT-based CC-protocol, while running the transactions that modify data-cells (e.g., read/write transactions) using a CC-protocol that allows serializable execution of such transactions (e.g., the 2PL CC-protocol). This way, the read-only transactions enjoy serializable execution while still not conflicting with the modifying transactions, and hence transaction concurrency is not hurt. This may be especially useful for long-running read-only transactions, such as the ones found, for example, in OLAP workloads.

The commit process performed at S340 supports different isolation levels and different CC protocols. At S350, a commit acknowledgment (ack) is returned to the client, thereby ending the execution of the received transaction.

The various embodiments mentioned in process 300 including the embodiments for creating the PiT, are discussed in greater detail in U.S. patent application Ser. No. 18/431,285, assigned to the common assignee, and it is incorporated herein by reference.

According to the disclosed embodiments, once a PiT is no longer required because the transaction or statement using the PiT has completed its execution, the PiT can be removed. Specifically, as discussed in detail below, when unified PiTs are in use, a (unified) PiT is no longer required when all its “enjoying transactions” and/or “enjoying statements” completed their execution. The removal of the PiT can be done immediately and asynchronously or deferred to a later time. After the removal of the PiT, some row-versions may become unnecessary. These row-versions are those that are not required anymore, as no PiT-read or current-read would access their data-cells. Such unneeded row-versions can then be removed. The removal of these row-versions can take place immediately and asynchronously or deferred to a later time.

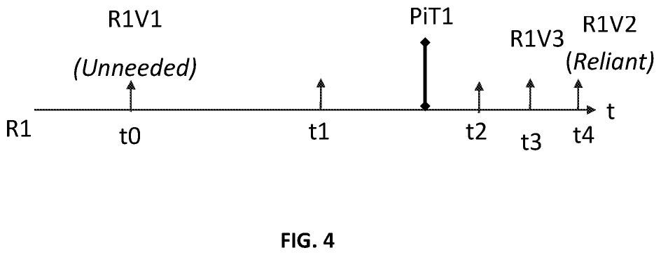

FIG. 4 is an example timeline demonstrating scenarios where the disclosed Interval-Based-Cleaning-Technique (IBC-technique) is applicable.

Generally, the disclosed IBC-technique, at a process referred to here as a row-version inspection, classifies committed row-versions as either “unneeded” or “reliant”. Unneeded row-versions can be removed immediately as, at the moment of inspection, such row-versions are not dependent on a removal of a PiT.

In the example shown in FIG. 4, row R1 is in a node N1. R1V1 and R1V2 are two consecutive row-versions of R1 whose CMTSs are t0 and t1, respectively; t2 is a moment in time after R1V2 is committed in the node. At t2, in order for a node to detect whether R1V1 is an unneeded row-version, the node determines whether there is no PiT in existence at t2 whose PiT timestamp is between the CMTSs of R1V1 and R1V2, i.e., having a PiT timestamp between t0 and t1. In this example, since there is no such a PiT timestamp, R1V1 is classified as unneeded.

On the other hand, reliant row-versions cannot be removed immediately as such row-versions are dependent on the removal of one or more PiTs. Following the example shown in FIG. 4, row R1 is in a node N1. R1V3 is a row-version of R1 whose CMTS is t3. t4 is a moment in time after R1V3 is committed in the node. At t4, in order for a node to detect whether R1V2 is an unneeded row-version, it is checked whether there is a PiT “in-between” R1V2 and R1V3. As there is such a PiT “in-between”, R1V2 is classified as a reliant row-version. As discuss in detail later, the removal of R1V2 can occur only after PiT1 is removed. To this end, R1V2 (a reliant row-version) is saved in data structures to allow its immediate identification when appropriate PiTs are removed, and hence then cleaning of reliant row-versions that turn into unneeded row-versions. The various embodiments for inspecting, classifying, and cleaning row-versions are described in detail below.

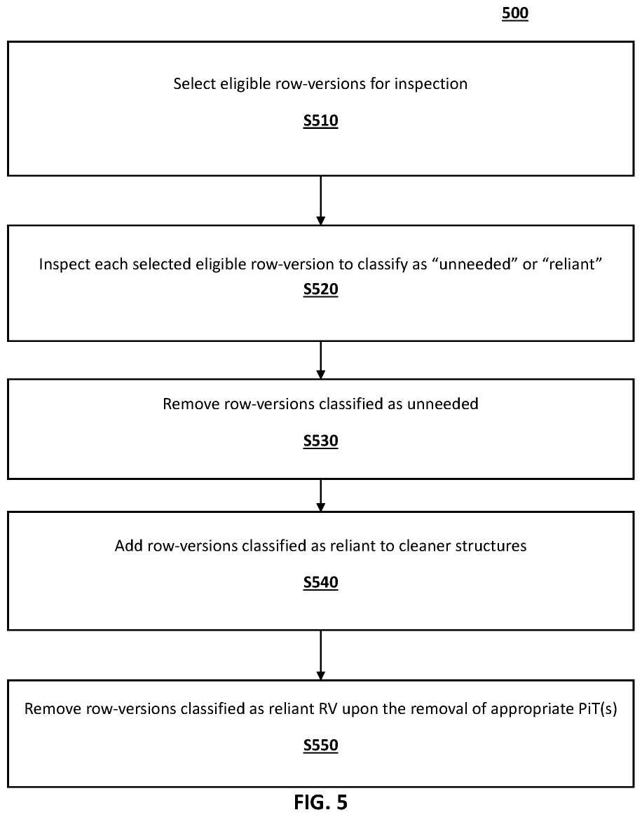

FIG. 5 is an example of a flowchart 500 for cleaning row-versions according to the disclosed embodiments. The disclosed technique for cleaning row-versions may be referred to as an IBC-technique.

At S510, eligible row-versions are selected for inspection. In an embodiment, row-versions that are inspected may be designated as inspected row-versions. Row-versions may also be designated as classified row-versions during inspection. Classified row-versions may be classified as unneeded or as reliant as part of a row-version inspection. A row-version may be classified as unneeded in relation to the inspected row-version. A row-version may be classified as reliant if, for example, there was a PiT “in-between” a classified row-version and an inspected row-version at the moment of inspection.

It should be noted that inspection of a row-version may result in a classification of the same row-version. In such cases, both the classified row-version and the inspected row-version refer to the same row-version.

It should be further noted that in the IBC-technique, once a row-version is determined to be unneeded or reliant, such a row-version will not need to be reclassified anymore. There may be other variations for an inspection procedure that do not use this rule, and such variations are compatible with this disclosure.

It should be further noted that in the IBC-technique, a row-version that was not yet inspected will not be classified. In contrast, a row-version that is currently inspected can be classified. There may be other variations for an inspection procedure that do not use this rule, and such variations are compatible with this disclosure.

The following is a description of the process for selecting row-versions for inspection according to some embodiments.

In a distributed database, and depending on the implementation of the distributed database, at a given moment in time (e.g., rt100), a node that has a cleaning engine performing the IBC-technique may not necessarily be aware of all the PiTs that were created and still exist at that time rt100. For example, in an embodiment, where the distributed database implements the SEQ-server and SEQ-agent (see FIG. 2), the SEQ-server streams PiT creation and removal information to the node, such that a certainty timestamp is maintained and monotonically increased, where the certainty timestamp is the timestamp up to which the existing PiT information inside the node is complete. If a PiT whose creation timestamp is smaller or smaller-equal than the certainty timestamp exists, then it is guaranteed that the node knows about the existence of that PiT. Similarly, in a non-distributed database, the certainty timestamp can also be maintained, where it is often trivially maintained as the node knows about all the PiTs that exist. In a distributed database that does not use the SEQ-server mechanisms, the certainty timestamp needs to be maintained, where the exact maintenance of the certainty timestamp depends on the way the PiT creation and removal mechanisms are implemented. As discussed above, the certainty timestamp or any equivalent timestamp can be generated by mechanisms other than the SEQ-server; examples of such mechanisms are discussed below.

A node with a cleaning engine (see FIG. 2) that utilizes the IBC-technique maintains a data structure known as the “Existing PiT Collection.” This data structure stores the current certainty timestamp and information about the PITs that exist. If a PiT with a creation timestamp equal to or less than the certainty timestamp exists, the node ensures it is aware of its existence and includes it in the existing PiT collection. PITs can be added to, referenced/retrieved from, and deleted from the existing PiT collection using their respective PiT timestamps. Additionally, the structure of the existing PiT collection should support the functionality to check for the existence of PiTs within a specified range of timestamps. In one implementation, the existing PiT collection is represented as a tree structure, although it is compatible with other data structure implementations.

The IBC-technique is notified on PiT creations and PiT removals, where these notifications are denoted as PiT-Creation Event and PiT-Removal Event, respectively. Those notifications carry the relevant information about the pertinent PiT, such as its timestamp. On a PiT-creation event, the pertinent PiT is added to the existing PiT collection. On a PiT-removal event, the pertinent PiT is removed from the existing PiT collection. Additional actions upon those events are described herein. In an embodiment, PiT-creation events arrive according to their PiT timestamp order. That is, a PiT-creation event for a later PiT (i.e., PiT with a higher timestamp) cannot be received prior to a PiT-creation event for an earlier PiT (i.e., a PiT with a lower timestamp). In addition, a PiT-removal event for a specific PiT (Px) cannot be received prior to the PiT-creation event for PiT Px. Alternative mechanisms of notifying PiT creations and PiT removals may be implemented, and the disclosure is compatible with such possible mechanisms.

According to an embodiment, a row-version that has been committed and not inspected and whose CMTS is smaller than the current certainty timestamp may be identified as an inspection-eligible row-version. This identification should be commenced after such a row-version becomes available. In an embodiment, when the current certainty timestamp is increased, for example, as a result of received streamed information, more such inspection-eligible row-versions may be added. Additionally, when a transaction has been committed, more inspection-eligible row-versions may be added, provided that by the time of the commitment, the current certainty timestamp is greater than the CMTS of the transaction. According to an embodiment, the inspection-eligible row-versions can be selected for inspection in an arbitrary order. This arbitrary approach to selection may be replaced by a more specific technique that may achieve the identification and/or selection of inspection-eligible row-versions in more efficiency.

The following is a description of a specific technique to efficiently identify and select for inspection an inspection-eligible row-version.

According to an embodiment, the node maintains a write-vector for each transaction, the write-vector contains identification for all the rows (and/or row-versions) the pertinent transaction wrote to. The node also maintains a data-structure referred to as the inspection-pending transaction collection. This data-structure contains all the committed transactions that wrote rows-versions in that node where those row-versions have not yet been inspected. The earliest (in terms of commitment timestamp) transaction of an inspection-pending transaction collection may be selected, provided that the collection is organized in a CMTS-order-preserving manner, such as a tree. If the selected transaction's CMTS is higher than the certainty timestamp, the procedure should be delayed until either the certainty timestamp sufficiently advances to be higher than the transaction's CMTS or a new transaction joins the inspection-pending transaction collection with a CMTS that is smaller than the certainty timestamp. If the selected transaction's CMTS is lower than the certainty timestamp, all row-versions modified by the transaction may be selected and inspected in any order. The transaction's write-vector may be used to identify these row-versions. Following the inspection of the row-versions, the transaction may be removed from the inspection-pending transaction collection. The next inspection-eligible transaction may then be identified. The process of selecting and inspecting all row-versions modified by the transaction may then be repeated. The write-vector of the first transaction may be removed. It should be noted that a tree is one example of data structure for maintaining the CMTS-order-preserving.

According to an embodiment, multiple row-versions may be selected for inspection and inspected in a parallel and/or asynchronous manner. Both the selection procedure and/or the inspection procedure may be performed in parallel and/or in parallel with each other and/or asynchronously, provided that standard means for avoiding race-conditions are applied. Parallelization may be achieved by selecting multiple row-versions modified by the same transaction, selecting multiple row-versions from multiple transactions, or a combination of both.

According to some embodiments, different strategies for choosing and ordering inspection-eligible row-versions for inspection may be utilized. For example, row-versions that are located near each other on the MVCC data-layout disk pages may be inspected together, or consecutively. This may improve I/O performance and/or minimize the disk I/O resource utilization. All such techniques are compatible with this disclosure.

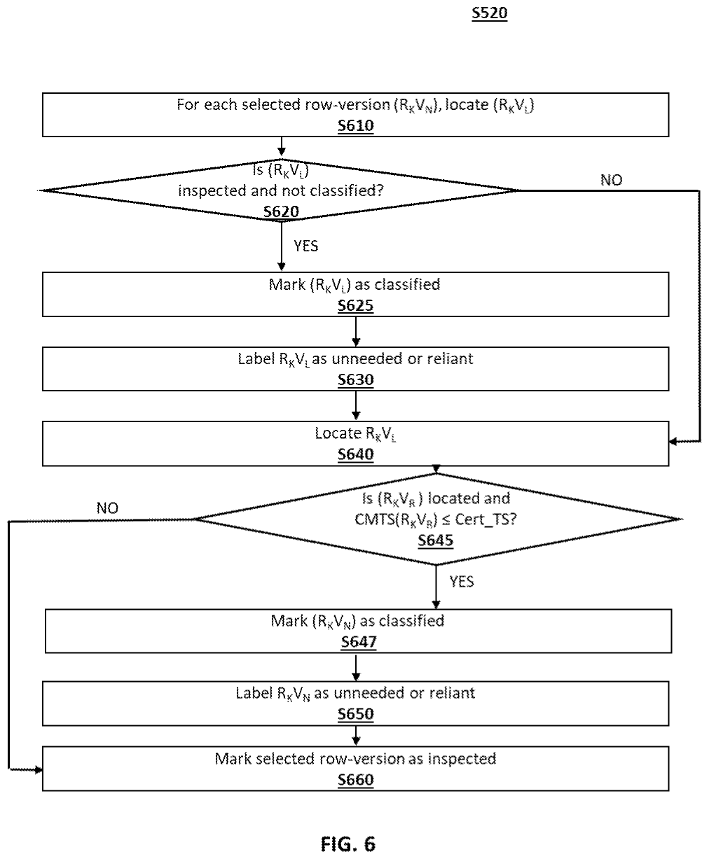

At S520, selected inspection-eligible row-versions are inspected to allow the classification of row-versions as “unneeded” or “reliant.” That is, as a result of the inspection, zero, one or more row-versions of the row of the inspected row-version are classified as “unneeded” or “reliant”. The various embodiments to perform S520 are discussed below with reference to FIG. 6. In an embodiment, S520 returns a list including zero, one or more row-versions marked as approved for removal.

At S530, the unneeded row-versions marked as approved for removal are removed. This includes deleting data stored, maintained, or associated with such row-versions. This removal may happen immediately after the inspection, or asynchronously, after the inspection.

At S540, row-versions classified as reliant row-versions are, added to one or more data structures. In an embodiment, such data structures (hereinafter “cleaner structures”) are utilized to allow immediate identification and communication of the removal of PiTs, thereby triggering the removal of row-versions that were classified as reliant row-versions, and upon the removal of the above-mentioned appropriate PiTs became unneeded. In an embodiment, the cleaner structures may include PiT Intervals (PINT), PINT Ranges (PRNG), PRNG Collections, and reliant row-version sets. The cleaner structures are discussed in greater detail below.

At S550, row-versions classified as reliant row-versions are removed or cleaned upon the removal of appropriate PiT(s). Generally, as will be discussed below in greater detail, when all the PiTs within the PINTs covered by a specific PRNG are removed, the reliant row-versions associated with that PRNG can be concluded as unneeded (i.e., changed from reliant to unneeded) and, hence, can be cleaned.

FIG. 6 is an example of a flowchart illustrating the operation of S520 FIG. 5 for inspecting row-versions according to the disclosed embodiments.

The following is a description of the process for performing an inspection on each selected row-version (that the selected inspection-eligible row version is denoted as “R_{K}V_{N}”). During the inspection, two indications are maintained for each row-version stored in the MVCC data-layout. These indications may be implemented as additional metadata to the metadata an MVCC data-layout already maintains for each of its stored row-versions, and any other ways to maintain and/or deduce the indications are compatible with this disclosure. The indications maintained are whether a row-version has already been inspected and whether a row-version has already been classified.

At S610, the left committed neighbor of row-version R_{K}V_{N} belonging to row R_{K}, R_{K}V_{L}, is located. The left committed neighbor is defined as the committed row-version of R_{K} with the highest (“latest”) CMTS that is lower (“earlier”) than the CMTS of R_{K}V_{N}, if it exists, at the moment the inspection takes place. The process of locating R_{K}V_{L} can be described as looking “backwards” in time.

At S620, it is checked if such R_{K}V_{L} exists, R_{K}V_{L} has already been inspected, and R_{K}V_{L} has not been classified. If so, R_{K}V_{L} is marked as classified (S625). Otherwise, execution proceeds to S640.

At S630, R_{K}V_{L} (marked as classified) is labeled as being either unneeded or reliant. In an embodiment, the existing PiT collection is checked for whether there exists a PiT such that the timestamp for the PiT exists within the range of timestamps between the CMTS of R_{K}V_{L} and the CMTS of R_{K}V_{N}. Such a PiT may be described as existing “in-between” R_{K}V_{L} and R_{K}V_{N}. In an embodiment where an “in-between” PiT does not exist, R_{K}V_{L} is labeled as an unneeded row-version. As noted above, such a row-version can be cleaned either synchronously or asynchronously. In an embodiment where an “in-between” PiT does exist, R_{K}V_{L} is identified as a reliant row-version and is added to the relevant “cleaner” structures.

At S640, the right committed neighbor of row-version R_{K}V_{N}, R_{K}V_{R}, is located. The right committed neighbor is defined as the committed row-version of R_{K} with the lowest (“earliest”) CMTS that is higher (“later”) than the CMTS of R_{K}V_{N}, if it exists, at the moment the inspection takes place. The process of locating R_{K}V_{R} can be described as looking “forwards” in time.

At S645, it is checked if such R_{K}V_{R} exists and the CMTS of R_{K}V_{R} is smaller than the certainty timestamp, then R_{K}V_{N} is marked as classified (S647). In an embodiment, it is checked if the CMTS of R_{K}V_{R} is smaller-or-equal to the certainty timestamp. If no such R_{K}V_{R} exists, execution continues with S660.

At S650, R_{K}V_{N} (marked as classified) is labeled as being either unneeded or reliant. To this end, the existing PiT collection is checked for whether there exists a PiT such that the timestamp for the PiT exists within the range of timestamps between the CMTS of R_{K}V_{N} and the CMTS of R_{K}V_{R}. Such a PiT may be described as existing “in between” R_{K}V_{N} and R_{K}V_{R}. For example, PiT1 in FIG. 4 is “in between” R1V2 and R2V3. In an embodiment, where an “in between” PiT does not exist, R_{K}V_{N} is identified as an unneeded row-version. Unneeded row-versions can be cleaned either synchronously or asynchronously. In an embodiment, where an “in between” PiT does exist, R_{K}V_{N} is identified or labeled as a reliant row-version and is added to the relevant cleaner structures.

At S660, the selected row-version R_{K}V_{N} is marked as inspected, where such indication can be stored in the MVCC data-layout. It should be noted that in embodiments where such an indication is also maintained in the write-vector, the indication may need to be set in the write-vector's row-version entry. It should also be noted that further maintenance for the write-vector and/or inspection-pending transaction collection may be performed following the indication of inspection. For example, if all row-versions of a transaction have been inspected, the transaction may be removed from the inspection-pending transaction collection.

It should be noted that the various embodiments discussed with reference to FIG. 6 are performed for each inspection-eligible row-version, as defined above.

Following are example timelines demonstrating the inspection and classification of row-versions.

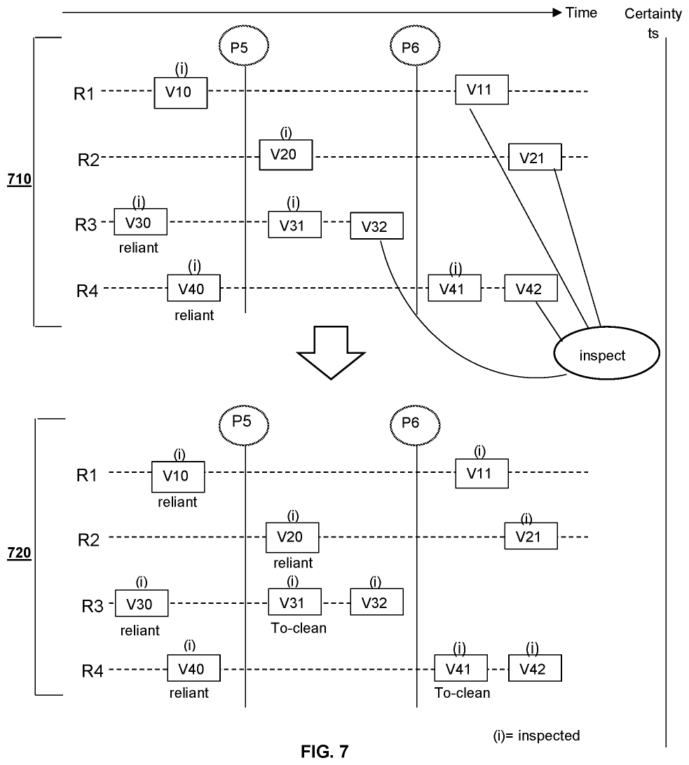

FIG. 7 shows an example diagram 700 of the inspection of four row-versions (V11, V21, V32, and V42) of four different rows (R1, R2, R3, and R4) and demonstrates the process of looking “backwards” in time. In the example, the other row-versions of those four rows (V10, V20, V30, V31, V40, V41) were already inspected, where only V30 and V40 were already classified. In the example diagram 700, at the moment of an inspection, there exist two PiTs, P5 and P6. The four row-versions are inspected sequentially. Section 710 shows a state of the row-versions before the inspection, and Section 720 shows a state of the row-versions after the inspection.

Within row R1, the row-version V11 is inspected. The left committed neighbor of V11, V10, is located. Since V10 is already inspected and not yet classified, V10 is then classified. A check is made to determine whether there exists any PiTs “in between” V10 and V11. In this example, since there are such PiTs (P5 and P6), V10 is classified as reliant, and actions are taken to add V10 to the relevant cleaner structures.

Within row R2, the row-version V21 is inspected. The left committed neighbor of V21, V20, is located. Since V20 is already inspected and not yet classified, V20 is then classified. In this example, there exists a PIT, P6, “in between” V20 and V21. V20 is classified as reliant, and actions are taken to add V20 to the relevant cleaner structures.

Within row R3, the row-version V32 is inspected. The left committed neighbor of V32, V31, is located. Since V31 is already inspected and not yet classified, V31 is then classified. In this example, although there exist two PiTs surrounding V31 and V32, there are no PiTs “in between” V31 and V32. As a result, V31 is classified as unneeded and is sent for cleaning.

Within row R4, the row-version V42 is inspected. The left committed neighbor of V42, V41, is located. Since V41 is already inspected and not yet classified, V41 is then classified. In this example, there are no PiTs “in between” V41 and V42. As a result, V41 is classified as unneeded and is sent for cleaning.

It should be noted that for the examples in FIG. 7, no right committed neighbors of the inspected row-versions result from looking “forwards” in time. Scenarios such as these, where the left committed neighbor is inspected and classified, and there is no right committed neighbor, are typical in cases where the inspection takes place shortly after commitment and the same row is not modified more than once during the period between commitment and inspection.

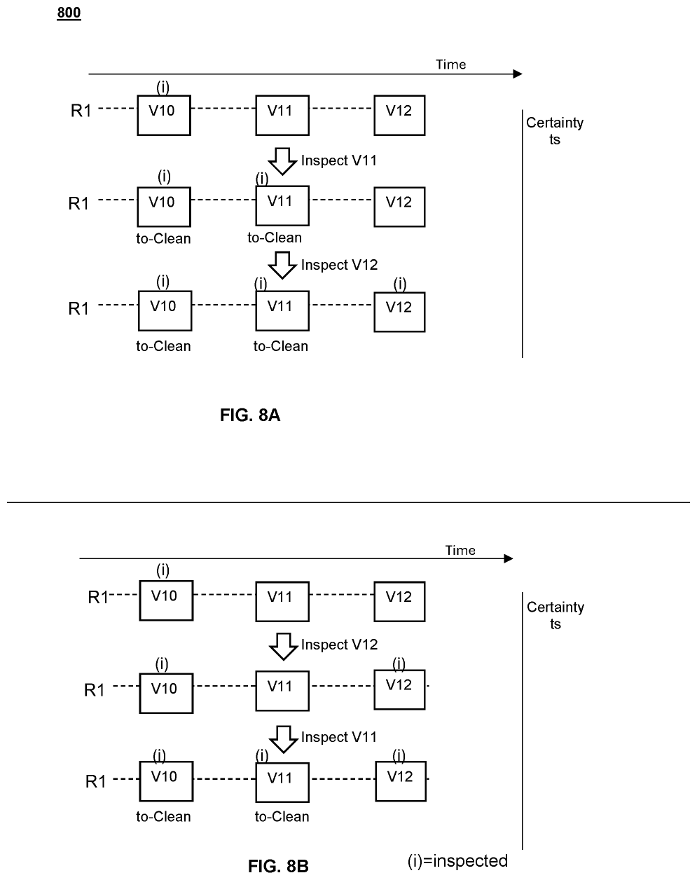

FIGS. 8A and 8B shows an example diagram 800 of an inspection where a row, R1, is modified twice before the modifications are inspected. In this example, a row-version V10 is already inspected. R1 is then modified and a row-version V11 is added. R1 is then modified again and a row-version V12 is added. Inspection-eligible row-versions can be inspected in any order. FIG. 8A demonstrates a sequence where V11 is inspected first and V12 is then inspected. FIG. 8B demonstrates a sequence where V12 is inspected first and V11 is then inspected.

As demonstrated in FIG. 8A, where V11 is inspected first, the left committed neighbor of V11 is first identified as V10 by looking “backwards” in time. Since V10 is already inspected and not yet classified, V10 is then classified. In this example, there are no PiTs “in between” V10 and V11. As a result, V10 is classified as unneeded and is sent for cleaning. It should be noted that row-versions classified as unneeded may be sent for cleaning asynchronously, and that row-versions to be cleaned may therefore not be immediately removed from the MVCC storage nor from the metadata that describe all row-versions. The row-versions classified as unneeded may therefore appear in further inspections as classified row-versions.

The right committed neighbor of V11 is then identified as V12 by looking “forwards” in time. Since the CMTS of V12 is smaller than the certainty timestamp, V11 is then classified. In this example, there are no PiTs “in between” V11 and V12. As a result, V11 is classified as unneeded and is sent for cleaning. It should be noted that in this example, the fact that V12 is not yet inspected does not matter. The property that non-inspected row-versions will not be classified is maintained by this procedure.

Following the inspection of V11 within FIG. 8A, V12 is inspected. The left committed neighbor of V12 is first identified as V11 by looking “backwards” in time. Although V11 is already inspected, it is also classified. No action is taken. It should be noted that in this example, since V11 was asynchronously sent for cleaning but the cleaning has not yet taken place, V11 is visible as a classified row-version during the inspection of V12.

The right committed neighbor of V12 is then determined not to exist by looking “forwards” in time. No action is taken.

As demonstrated in FIG. 8B, where V12 is inspected first, the left committed neighbor of V12 is first identified as V11 by looking “backwards” in time. V11 is neither classified nor inspected. No action is taken.

The right committed neighbor of V12 is then determined not to exist by looking “forwards” in time. No action is taken.

Following the inspection of V12 within FIG. 8B, V11 is inspected. The left committed neighbor of V11 is first identified as V10 by looking “backwards” in time. Since V10 is already inspected and not yet classified, V10 is then classified. In this example, there are no PiTs “in between” V10 and V11. As a result, V10 is classified as unneeded and is sent for cleaning.

The right committed neighbor of V11 is then identified as V12 by looking “forwards” in time. Since the CMTS of V12 is smaller than the certainty timestamp, V11 is then classified. In this example, there are no PiTs “in between” V11 and V12. As a result, V11 is classified as unneeded and is sent for cleaning.

Both scenarios that are demonstrated in FIGS. 8A and 8B achieve the same result: V12 survives, and V11 and V10 are sent for cleaning. It should be noted that in this example, there are no PiTs. The existence of PiTs would possibly change the classification of row-versions from “unneeded” to “reliant”, but the procedure would otherwise remain the same.

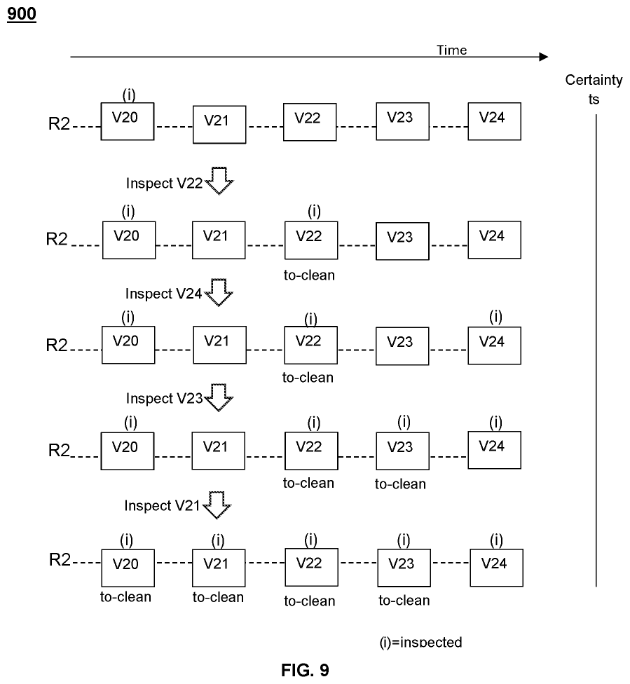

FIG. 9 shows an example diagram 900 of an inspection where a row, R2, is modified four times before the modifications are inspected. In this example, a row-version V20 is already inspected. R2 is then modified and a row-version V21 is added. R2 is then modified again and a row-version V22 is added. R2 is then modified two more times, and row-versions V23 and V24 are added. In this example, the inspection-eligible row-versions are inspected in an intentionally random sequence. V22 is first inspected, followed by V24, V23, and V21. This sequence of inspections results in V20, V21, V22, and V23 being classified as unneeded and sent for cleaning.

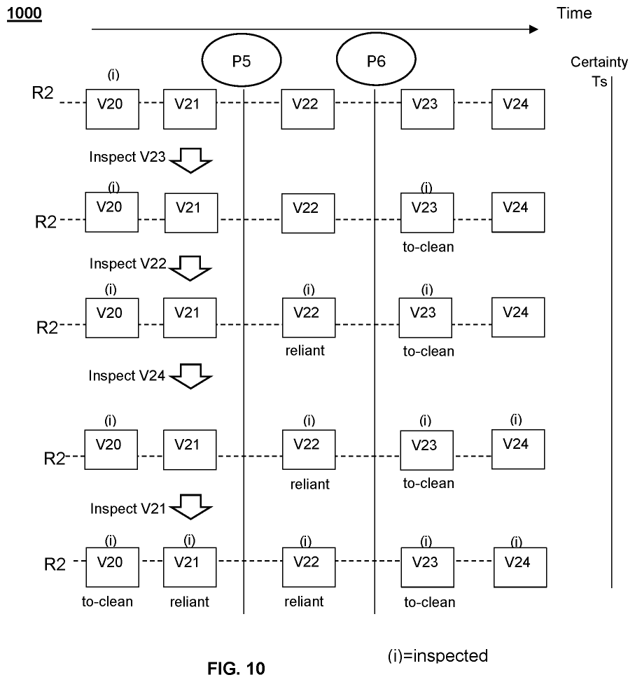

FIG. 10 shows an example diagram 1000 of a similar scenario to that of FIG. 9, where a row, R2, is modified four times before the modifications are inspected, which results in the row-versions V21, V22, V23, and V24. In this example, V23 is first inspected, followed by V22, V24, and V21. Additionally, two PiTs (P5 and P6) exist in this example, resulting in two reliant row-versions (V21 and V22) and two unneeded row-versions (V20 and V23) that are sent for cleaning.

It should be noted that there may be numerous potential variations for the procedure demonstrated in FIGS. 7-10 that are compatible with the present disclosure. For example, during the inspection of a row-version, when looking “forwards” in time, if the CMTS of the right committed neighbor of the row-version is larger than the certainty timestamp and there is a PiT “in between” the row-version and its right committed neighbor, the row-version could be classified as reliant, despite the fact that the right committed neighbor is beyond the certainty timestamp. However, the inspected row-version could not be classified as unneeded, as a PiT with a timestamp greater than the commitment timestamp and smaller than the CMTS of the right committed neighbor could later appear, making the row-version reliant and not unneeded.

It should also be noted that other inspection algorithms may be able to achieve the goal expected by the procedure demonstrated in FIGS. 7-10. For example, an inspection algorithm could be made to locate the closest inspected row-version to the left and to the right instead of the closest committed neighbor. Such an approach may allow “looking to the right only” if there is such a pertinent row-version to the right whose CMTS is lower or lower-equal to the commitment timestamp. Such an approach may also allow “looking to the left” if there is a lack of a pertinent row-version to the right. Some variations of the inspection algorithm may make it unnecessary to explicitly mark an entry as “classified”. Other variations may perform as many classifications as possible of a row's row-versions, where the row corresponds to a specific inspected row-version. All such variations to the inspection procedure are compatible with the present disclosure and can be used instead of or in addition to the procedure demonstrated in FIGS. 7-10.

It should also be noted that the procedure demonstrated in FIGS. 7-10 should be made to maintain the following correctness principles. A “current” committed row-version, or a row-version with the highest CMTS (i.e., highest for a given row), should not be identified as unneeded or reliant as it cannot be removed. A reliant row-version should not be identified as unneeded as such an identification would result in the row-version being prematurely cleaned, which could lead to a wrong result for PiT-reading that would otherwise have returned the value stored in the missing row-version. A row-version that is unneeded should not be left undetected indefinitely, as a delay in detection would result in unnecessary resource consumption.

It should also be noted that the inspection procedure may, in some situations, classify what is an unneeded row-version as reliant row-version. Such a classification does not undermine correctness of the inspection procedure. The cleaning of that row-version is merely delayed until the pertinent PiTs are removed. A version of an algorithm that classifies effectively unneeded row-versions as reliant may be modified to classify such row-versions as unneeded at the cost of additional computational resources.

It should also be noted that the procedure demonstrated in FIGS. 7-10 avoids re-classifying an already-classified row-version and avoids classifying an uninspected row-version. These two principles allow for various mechanisms and techniques presented by this disclosure to be simplified. However, it is possible for an inspection procedure not to comply with one or both of these principles while maintaining compatibility with the present disclosure. For example, it is possible for a procedure to allow for a row-version classified as reliant to be reclassified as unneeded. It is also possible for a procedure to allow for an uninspected but committed row-version to be classified as unneeded or reliant, if such a classification would be correct.

It should also be noted that in a non-distributed database environment and in a distributed database environment where each commitment of a transaction is performed synchronously across all nodes, or at least all nodes with modifying agents of the transaction, the IBC-technique can be made to detect all the commitments of the relevant transactions synchronically. In such cases, it may be possible for the inspection to be performed in the order of the commitments, or it may be possible for the row-versions of a given row to be inspected by the order of their CMTSs. This may allow for an algorithm in which row-versions are only inspected “backwards in time”.

In one example embodiment, a specific strategy to maintain PiT Intervals (PINTs) is followed. A PINT is an interval of timestamps [x, y], where x≤y. It is denoted that the interval “Starts at x” and “Ends at y”. The interval includes all the timestamps between x and y, including x and y. A PINT [x, y] can be conceptually viewed as containing all the PiTs with timestamps that are between x and y (inclusively). An Open-Ended PINT (PINTx) is a PINT that covers an interval that starts at timestamp x and ends at the certainty timestamp but is dynamically expanded when the certainty timestamp increases. Maintaining PINTs includes creating, adding, updating, and removing PINTs.

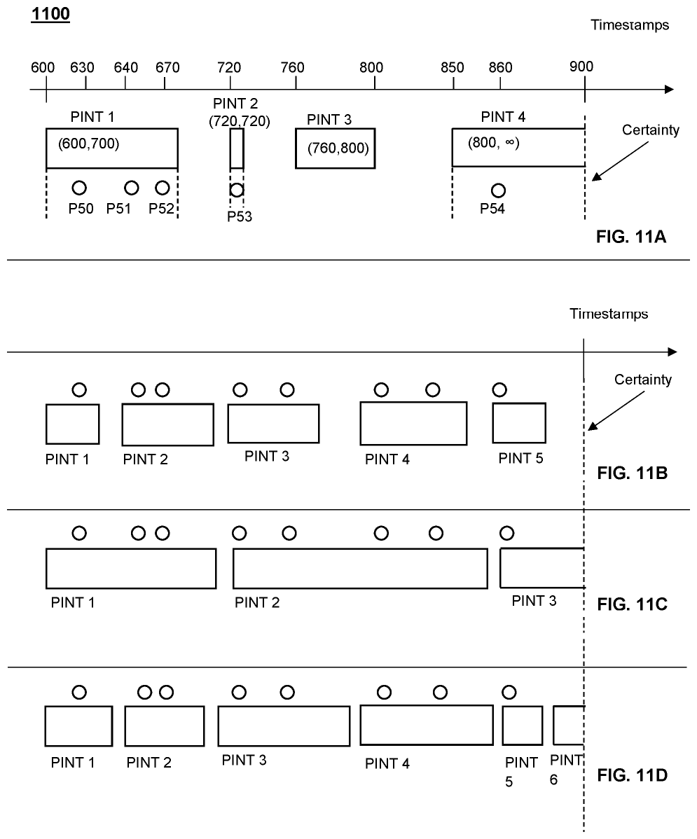

FIGS. 11A-11D show an example diagram 1100 demonstrating the properties of PINTs, Open-Ended PINTs, and PiT-empty PINTs. As demonstrated in FIG. 11A, the PINT denoted as PINT1 is a PINT that contains the PiTs P50, P51, and P52, which are located at timestamps 630, 640, and 670, respectively, and encompasses the range of timestamps between 600 and 700, inclusive. The PINT denoted as PINT2 is a PINT that contains the PIT P53 at timestamp 720 and encompasses a single timestamp, 720. PINT2 is therefore an example of the narrowest PINT possible. The PINT denoted as PINT3 contains no PiTs and encompasses the range of timestamps between 760 and 800, inclusive. PINT3 is therefore an example of a PiT-empty PINT. The PINT denoted as PINT4 is a PINT that contains the PIT P54 at timestamp 860 and encompasses the range of timestamps from 800 up to and including the certainty timestamp. PINT4 is an example of an Open-Ended PINT.

It should be noted that since the certainty timestamp is the timestamp up to which the existing PiT information inside the node is complete, no PiTs would be added at timestamps that are lower or equal to the certainty timestamp. As applied to FIG. 11A, no PiTs would therefore be added to PINT1, PINT2, or PINT3. As for PINT4, new PiTs with a timestamp higher than the current certainty timestamp may be added to PINT4 as long as PINT4 remains open-ended.

In an embodiment, a cleaner structure “PINT collection” may be utilized by an IBC-technique. A PINT collection is defined as a set of non-overlapping PINTs that include all the PiTs that currently exist up to the certainty timestamp. It should be noted that the PINTs of a PINT collection do not necessarily cover all the timestamps up to the certainty timestamp. It should also be noted that the end timestamp of one PINT within a PINT collection cannot be the same as the start timestamp of another PINT within the same PINT collection, as this would be considered an overlap. It should also be noted that a PINT collection may or may not contain an open-ended PINT. It should be further noted that PINT collections may be created and maintained by various techniques, some of which are discussed below.

FIGS. 11B, 11C, and 11D demonstrate the properties of three distinct PINT collections that contain the same set of PiTs and relate to the same certainty timestamp. The PINT collection shown in FIG. 11B contains no open-ended PINTs. In contrast, the PINT collection shown in FIG. 11C contains an open-ended PINT, denoted as PINT3, which is not PiT-empty. The PINT collection shown in FIG. 11D contains an open-ended PINT, denoted as PINT6, which is currently PiT-empty. It should be noted that the FIG. 11A also demonstrates a PINT collection containing four PINTs, including a PiT-empty PINT, PINT3, and an open-ended PINT, PINT4.

Given that the PINTs within a PINT collection do not overlap, it should be noted that in an embodiment, it may be possible to denote a PINT within a PINT collection as “earlier” or “later” than another PINT within the PINT collection. For example, a first PINT whose end timestamp is smaller than the start timestamp of another second PINT may be described as being earlier than the second PINT. It should also be noted that it may also be possible to describe a single timestamp as being “earlier” or “later” than a PINT. For example, a timestamp that is larger than the end timestamp of a PINT may be described as being later than the PINT. As an additional example, within FIG. 11B, PINT3 is earlier than PINT5, and PINT2 is later than PINT1.

Given that the flow of time is visualized as being from left to right, it should be noted that in an embodiment it may be possible to denote a PINT within a PINT collection as the “left neighbor” or “right neighbor” of another PINT within the PINT collection. The left neighbor of a PINT, PINTn, is the latest PINT that is still earlier than PINTn. The right neighbor of PINTn is the earliest PINT that is still later than PINTn. For example, within FIG. 11B, PINT4 is the right neighbor of PINT3 and PINT3 is the left neighbor of PINT4.

In an embodiment, the cleaning engine may instantiate one PINT collection that may be updated over time. In another embodiment, multiple PINT collections may be instantiated and maintained. As a non-limiting example, the existence of multiple MVCC storages may benefit from the instantiation of a separate PINT collection for each storage. Such PINT collections may contain distinct sets of structures, which may include PINTs, PRNGs, PRNG collections, and reliant row-version sets. Although this specification will continue to refer to an embodiment wherein there exists one PINT collection, embodiments wherein multiple PINT collections exist are fully supported by the present disclosure.

In an embodiment, each PINT within a PINT collection may be represented by a PINT object that contains information about the PINT. This information may include, but is not limited to, any of the following: a start timestamp, an end timestamp, an indication of whether the PINT is open-ended, and an anchor for the PRNG collection associated with the PINT. A PINT object may also contain information about properties that may be required for specific embodiments, including information required for specific PINT strategies.

In an embodiment, a PINT collection may be modified by a number of operations. Such operations may include, but are not limited to, the following operations. A PINT may be created, either as an open-ended PINT or as a non-open-ended PINT, by a PINT strategy and added to the PINT collection. The latest PINT may be located by a PINT strategy. Once a PINT is located, the PINT's properties may be read or modified. An open-ended PINT may be converted to a non-open-ended PINT by a PINT strategy by being provided an end timestamp. Given a specific timestamp, a PINT that covers the timestamp may be identified. Given that a specific timestamp is not covered by a PINT, a PINT that constitutes the left neighbor or the right neighbor of the timestamp may be identified. A PINT may be removed from the PINT collection by a PINT strategy. Given a specific PINT, the PINT's left neighbor PINT or right neighbor PINT may be identified.

In an embodiment, a PINT collection may be realized as a tree data structure. The tree data structure may be keyed by the PINT collection's leftmost PINT timestamp or by any relevant timestamp. The tree data structure may be saved as a persistent or page-oriented data structure.

It should be noted that the IBC-technique is compatible with any data-structure implementation for a PINT collection within an embodiment, including embodiments that do not involve a persistent or page-oriented data structure.

It should be noted that in some embodiments, some of a PINT collection's pages may be cached in RAM. In some other embodiments, a complete copy of a PINT collection may be held in RAM. In such embodiments, the performance and efficiency of operations modifying the PINT collection may be improved.

In an embodiment, the method by which a set of PINTs within a PINT collection may be determined is known as a PINT strategy. The disclosed embodiments provide multiple strategies for creating and maintaining PINTs in a PINT collection. A strategy is selected in order to optimize the utilization of computer resources. A PINT may be viewed as an indirect container of reliant row-versions, such that all of the PINTs in a PINT collection indirectly contain all reliant row-versions. A PINT strategy involving the creation of narrower PINTs, which may correspond to smaller differences in start and end timestamps and/or their real time correlates may result in a faster, or “tighter”, determination that a reliant row-version has become unneeded and is ready for cleaning.

The following PINT strategies describe the creation, maintenance, and removal of PINTs. It should be noted that, with some exceptions that are described later in detail, when a PINT becomes PiT-empty, the PINT is no longer needed and is removed. When a PINT is removed, the reliant row-versions and other structures contained within the PINT are also managed.

In an embodiment, a PINT strategy includes a fixed-rough-interval, which is an interval that is “meaningfully lengthier” than the typical time between PiTs and yet not “hugely lengthy”. A strategy that utilizes a fixed-rough-interval is denoted as a fixed-rough-interval strategy. For example, where the typical time between PiTs is 1/1000 of a second, a fixed-rough-interval strategy may involve an interval of 1 minute, which would be “meaningfully lengthier” than 1/1000 of a second yet not hugely lengthy. In an example embodiment, the fixed-rough-interval is 1 minute.

Multiple possible PINT strategies, including the fixed-rough-intervals strategy, utilize both the cleaning engine's real-time timer and timestamps. There is a common relationship between a PINT's timestamps and the “real time interval” associated with a PINT, which denotes the bounds of the PINT according to the cleaning engine's real-time timer. For example, given a cleaning engine using a fixed-rough-intervals strategy, the cleaning engine may define an interval as being one minute following a specified time, as determined by the cleaning engine's real-time timer. During the one-minute interval, if a PiT-creation event notification occurs, a PINT corresponding to the interval is created, which will include all PiTs whose PiT-creation events occurred during the real-time one-minute interval. The PINT's start timestamp and end timestamp will therefore be associated with the real-time interval. The real-time interval may be referred to as a Real-Time Interval, or RTINT.

The following is a description of how PINTs may be created by a fixed-rough-interval strategy. In an embodiment, a cleaning engine may run a one-minute timer representing a fixed-rough-interval RTINT. In an embodiment where a PiT-creation event notification occurs during the one-minute interval, the PINT strategy may check for the existence of an open-ended PINT describing the one-minute RTINT. If such a PINT does exist, no action is taken, except that the newly created PiT may be viewed as contained by the existing PINT. If such a PINT does not exist, an open-ended PINT for the RTINT may be created and denoted as PINTx. The start timestamp for PINTx is set to be the timestamp of the newly created PiT which the PiT-creation event described. The end timestamp for PINTx, as it is an open-ended PINT, is set to “infinity”. Upon the expiration of the one-minute timer, if an open-ended PINT describing the one-minute RTINT does exist, an end timestamp for the open-ended PINT equivalent to the timestamp of the latest PiT that is contained by the PINT may be created, converting the open-ended PINT into a “regular” PINT. If an open-ended PINT does not exist, no action is taken.

It should be noted that a search for an open-ended PINT may be conducted efficiently. As an open-ended PINT can only ever be the latest PINT in a PINT collection, the search may locate the latest PINT in the PINT collection and examine whether that PINT, if it exists, is open-ended.

The procedure described here allows for the creation of PINTs for every one-minute RTINT at which a PiT is created. It should be noted that the timestamps of such PINTs are not the border real-time timestamps of the one-minute RTINTs. Instead, the timestamps are related to the earliest and latest PiTs created within the one-minute RTINT. For example, a PINT's end timestamp under this procedure may be the timestamp of the latest PiT that was created and still existed at the time that the one-minute interval ended. There may exist variations under some embodiments for assigning timestamps to PINTs according to a PINT strategy. Such variations may be viewed as different strategies or as variations of the same strategy and are compatible with this disclosure.

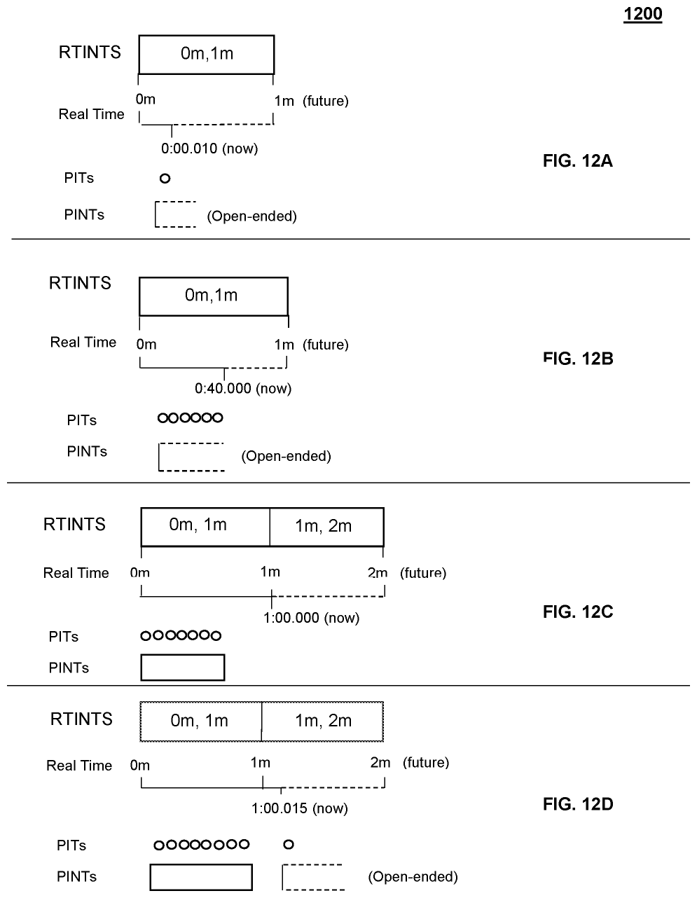

FIGS. 12A-12D shows an example diagram 1200 demonstrating the dynamics of a fixed-rough-intervals strategy using RTINTs. In this example, a cleaning engine's one-minute timer is started at time 0, resulting in the establishment of an RTINT with a left bound at time 0 and a right bound at time 1:00. The RTINTs to which the one-minute timer correlates are represented by the first row of each of the sections of FIG. 12.

At FIG. 12A, the elapsed time has a real-time value of 0:00:010 (0 minutes, 0 seconds, 10 milliseconds) and a PiT creation event notification occurs with a corresponding PiT timestamp of 1000. Since there are no existing open-ended PINTs at this stage, an open-ended PINT (1000, ∞) is created.

At FIG. 12B, the elapsed time has a real-time value of 0:40:000 (0 minutes, 40 seconds, 0 milliseconds) and multiple PiTs have been created. All PiTs created up to this point are included in the open-ended PINT (1000, ∞).

At FIG. 12C, the elapsed time has a real-time value of 1:00:000 (1 minute, 0 seconds, 0 milliseconds) and the one-minute timer triggers. The PINT (1000, ∞) is assigned an end timestamp of 3300, which is the timestamp of the latest PiT that exists at that moment. With the triggering of the one-minute timer, a new RTINT with a left bound at time 1:00 and a right bound at time 2:00 is established.

At FIG. 12D, the elapsed time has a real-time value of 1:00:015 (1 minute, 0 seconds, 15 milliseconds) and a PiT creation event notification occurs with a corresponding PiT timestamp of 3400. Since there are no existing open-ended PINTs at this stage, an open-ended PINT (3400, ∞) is created.

In an embodiment, the procedure demonstrated in FIGS. 12A-12D continues as more time elapses. It should be noted that as long as PiTs are created within every minute that has elapsed, a PINT will be created every minute. If there is a real-time minute where no PiT is created, then a PINT will not exist for that real-time minute.

The following is a description of how PINTs may be removed by a fixed-rough-interval strategy. In an embodiment where a PiT-removal event notification has occurred for a PiT, a PINT strategy may identify a PINT that covers the PiT by using a PINT collection. The PINT may then be checked for the existence of any PiTs within the PINT that have not yet been removed. If such a PiT exists, no action is taken. If such a PiT does not exist, the PINT has become PiT-empty and may be removed. It should be noted that this procedure removes any existing PINT once the PINT becomes PiT-empty.

According to some embodiments, the PINT strategy above typically removes PINTs at a low frequency, for example, every minute. The low frequency is generally desired because it contributes to the overall efficiency of the mechanisms of the embodiment. However, in an embodiment, the PINT strategy described above may result in a higher PINT creation/removal frequency. That is, the open-ended PINT may be created and removed many times during the pertinent one-minute RTINT. This may result when PiTs are created and removed very frequently in a way that leaves the open-ended PINT PiT-Empty. At each such removal, the open-ended PINT may be removed and created once the next PiT is created, provided that the one-minute RTINT has not been terminated. The higher PINT creation/removal frequency may lead to “tighter” cleaning of reliant row-versions before the entire one-minute RTINT has been terminated. However, this exceptional case may also cause overall efficiency of computer resource consumption to be degraded.

To avoid the exceptional case described above, the following variation may be used. In an embodiment, when an open-ended PINT becomes PiT-empty, it is not removed by the PINT strategy. Instead, the PINT is removed only when it is about to become a non-open-ended PINT once the one-minute RTINT ends, given that the PINT is PiT-empty in that moment.

The fixed-rough-intervals strategy demonstrated by FIG. 12 creates PINTS whereby each PINT is associated with a one-minute RTINT that is also aligned to one-minute boundaries. Each such RTINT may be associated with a PINT, given that there exists one or more PiTs within the one-minute RTINT. The alignment to one-minute boundaries is achieved within the procedure demonstrated by FIG. 12 by the one-minute timer. In an embodiment, a PINT strategy's alignment of RTINTs to real-time boundaries may be referred to as a “cycle”. The example demonstrated by FIG. 12 uses a 1-minute cycle. It should be noted that the start and end timestamps for PINTs under the fixed-rough-intervals strategy may not be the correlated with the exact one-minute interval boundaries. The PINT start and end timestamps will be typically “narrower” than those correlated with the RTINT boundaries, while still existing within the one-minute interval boundaries. However, in an embodiment, it may be convenient to view such a PINT as being associated with an RTINT.

The fixed-rough-intervals strategy demonstrated by FIG. 12 allows for the efficiency of a cleaning engine to be meaningfully increased by aggregating one or more PiTs into the same PINT. In an embodiment where a cleaning engine uses a fixed-rough-intervals strategy, there may be only a minimal delay in cleaning a reliant row-version as compared to a “tighter” strategy that utilizes narrower PINTs. For example, a fixed-rough-intervals strategy with a one-minute RTINT may often allow a reliant row-version to be detected as unneeded with a delay of up to one minute. This delay may be reasonable for multiple use-cases. For example, a use-case requiring a shorter delay, a shorter RTINT may meaningfully reduce such a delay.

In an embodiment where a fixed-rough-intervals strategy is utilized by a cleaning engine and the strategy utilizes a one-minute cycle, as time progresses, older PINTs may tend to be removed as the PiTs they contain are removed. This continuous removal of older PINTs may result in a relatively small number of PINTs existing at the same time. As a non-limiting example, if the activities of a database are short such that all associated PiTs do not exist for more than one second, there should not exist more than two PINTs at the same time. As another non-limiting example, if most associated PiTs within a database do not exist for more than one second and 10 PiTs created every minute exist for a period of between two and five minutes, there will typically exist approximately five or six PINTs at the same time.

As another non-limiting example, if most associated PiTs within a database do not exist for more than 20 seconds and one PiT created every 10 minutes exists for a period of between four and five minutes, there will exist approximately two or three PINTs at the same time. As another non-limiting example, if many PiTs within a database exist for a lengthy period, such as a few hours, there may be a correspondingly large number PINTs. However, the number of PINTs in this example may not exceed the number of minutes for which the lengthiest PiT has existed. It should be noted that the number of PINTs existing at the same time within a PINT collection may affect the utilization of various compute resources. A smaller number of PINTs may result in better efficiency.

The fixed-rough-intervals strategy demonstrated by FIG. 12 may be effective for many use-cases due to its tendency to aggregate a large number of PiTs within a single PINT. However, in some embodiments the fixed-rough-intervals strategy may not sufficiently reduce the number of PINTs, which may result in decreased efficiency due to increased utilization of resources. For example, if a large number of PiTs within a database remain existing for a lengthy period, a larger number of PINTs may sometimes exist at the same time.

In an embodiment, a PINT strategy that limits the number of PINTs within a PINT collection may be known as an “N-level PINT strategy”. It should be noted that for some use-cases, the N-level PINT strategy may not meaningfully increase a database's overall efficiency relative to a fixed-rough-intervals strategy. However, in some other use-cases, and especially in the cases where the usage of the fixed-rough-intervals strategy would result in a large number of PINTs, a limit to the number of PINTs set by an N-level PINT strategy may result in better overall efficiency due to decreased utilization of resources, as well as persistent data-structure simplifications and may result in reduction of I/O overhead.

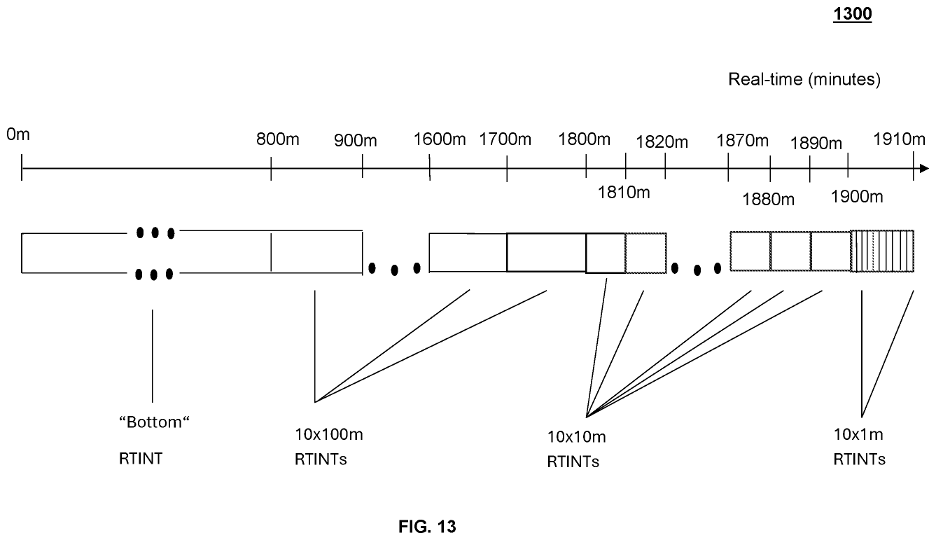

In an embodiment, it may be possible to minimize the number of PINTs by allowing for fixed-rough-interval RTINTs of one minute for a recent real-time period while covering older real-time periods by larger RTINTs and larger PINTs, for example, periods of 10 minutes or 100 minutes. It may also be possible to allow for a “bottom” RTINT and a potential “bottom” PINT that may cover PiTs that are older than a specified point. FIG. 13 is an example diagram 1300 demonstrating how such an RTINT configuration may appear at time 1910 minutes in an embodiment. Within such an embodiment, the PINT strategy would have at most one PINT associated with each RTINT. In the example FIG. 13, the RTINTs are drawn to represent all potential PINTs that may be covered by this strategy.

Within the example strategy demonstrated by FIG. 13, the overall number of PINTs is limited to 31. In contrast, a fixed-rough-intervals strategy for the same set of PiTs, provided that all PiTs are extremely lengthy, may result in a number of PINTs that would approach 1910.

Allowing for PINTs associated with older periods of time to be broader may result in reducing in resource utilization while minimizing any relative penalty associated with a delay in cleaning the broader PINT. For example, if a row-version is reliant for one hour, there may be no meaningful difference in efficiency to have it cleaned 10 minutes after it becomes unneeded instead of one minute after it becomes unneeded.

Within an N-level PINT strategy, a configuration such as the one demonstrated by FIG. 13 should be maintained over time in an efficient manner. In order to maintain the configuration, the strategy may allow PINTs to be combined by “converging” into a broader PINT as they get older, the broader PINT being associated with a broader RTINT. Such a convergence would allow for all reliant row-versions that were (indirectly) contained by the original PINTs to be included within the converged PINT.

It should be noted that there may be PINT strategies other than the N-level PINT strategy that may increase cleaning engine efficiency by reducing the number of PINTs. The present disclosure is compatible with all of these PINT strategies.

In an N-level strategy, up to “N” levels of PINT “sizes” may be constructed. Each level may be associated with a corresponding level of RTINT such that a lower level is broader than a higher level. This strategy is called N-Level as the idea is to construct up to N levels of PINT “sizes” (“durations”), associated with corresponding N levels of RTINTs, where each level is broader than a higher level.

It should be noted that while some PINT strategies are described by the present disclosure, the present disclosure is compatible with any PINT strategy.

It should also be noted that in an embodiment, a PINT strategy may construct PiTs according to the narrowest possible construction. Such a strategy may be denoted as a “PINT-per-PiT” strategy. In a PINT-per-PiT strategy, following a PiT-creation notification event, a PINT is created corresponding to the PiT such that the start timestamp and end timestamp of the PINT is equivalent to the timestamp of the PiT. The PINT is then added to the PINT collection. The PINT is removed upon a corresponding PiT-removal notification event. It should be noted that the PINT-per-PiT strategy does not use open-ended PINTs.

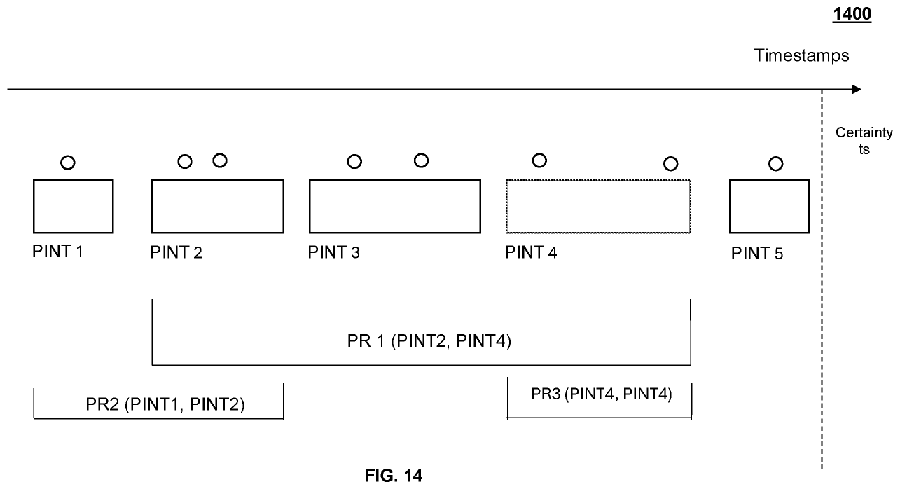

In an embodiment, a range of consecutive, or neighboring, PINTs may be denoted as a PINT range (PRNG). A PRNG includes PINTs covering all the timestamps in the range and may also include “holes” in between neighboring PINTs. FIG. 14 is an example diagram 1400 that demonstrates a PRNG structure according to an embodiment. As demonstrated in FIG. 14, there exist PRNGs PR1, PR2, and PR3. PR1 covers PINT2, PINT3 and PINT4, PR2 covers PINT1 and PINT2, and PR3 covers PINT4. A PRNG may be denoted by the nomenclature PRn [PINTx, PINTy], where PINTx is the leftmost PINT covered by PRn, and PINTy is the rightmost PINT covered by PRn. PRn covers all PiTs in between and including PINTx and PINTy.

In an embodiment, a PRNG may be realized as an object that can be created and removed under specific conditions and may be denoted as a “PRNG object”. A PRNG object may maintain the following properties: within a PINT collection, not all possible PRNG objects covering all possible PINT range permutations may exist. A PRNG object may be constructed as a container of reliant row-versions and may only be created when a first reliant row-version is added to that PRNG object. A PRNG object may change its association with a PINT range in some of the cases where changes to the PINTs included by the corresponding PINT range take place. As a non-limiting example, if a rightmost PINT in the associated PINT range is removed as a result of all of the PINT's PiTs being removed, the original association of the PRNG object with the PINT range may change. Such a change may occur without the need to take any specific action. The changes in association between a PRNG object and an associated PINT range may result in multiple PRNG objects that are effectively associated with the same range of PINTs. As discussed in detail, later, a PRNG object may be described as being embedded within a collection of PRNGs, which may be denoted as a “PRNG collection”.

As a PRNG object serves as a container of reliant row-versions, during inspection, reliant row-versions are added to a PRNG object. A reliant row-version can be added to an existing PRNG object or to a new PRNG object that is created on-the-fly. At any moment, a reliant row-version is contained by exactly one PRNG object.

An addition of a row-version to an object should maintain the following principle: if a row-version RV1 is contained by PRNG object PR1 [PINTx, PINTy] and all the PiTs covered by PR1 are removed, it is safe to conclude that RV1 became an unneeded row-version. Hereafter, this principle will be referred to as the PRNG Fitness Principle.

In one embodiment, the “tightest” PRNG object is selected as the ideal PRNG object to which a specific reliant row-version may be added. For example, during a moment of inspection, there may be a row-version R1V10 of row R1 that is classified as a reliant row-version. While maintaining the PRNG fitness principle, the tightest PRNG is PR1 [PINT_{L}, PINT_{R}] where PINT_{L} is a PINT that contains the earliest PiT out of the set of PiTs “in between” R1V10 and its right committed neighbor row-version R1V11, or the “middle PiTs”, and PINT_{R} is the PINT that contains the latest PiT out of the middle PiTs.

It should be noted that since R1V10 is a reliant row-version, it is guaranteed that it has a right committed neighbor row-version R1V11 and it is guaranteed that, at the moment of inspection, there is at least one PiT (from the cleaning engine's perspective) “in between” R1V10 and R1V11.

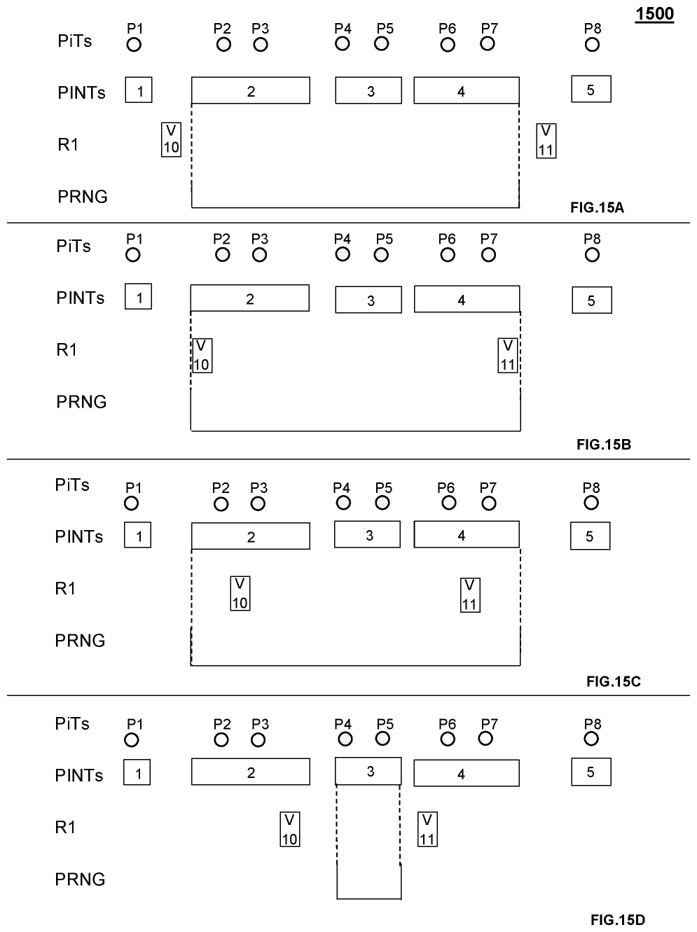

FIG. 15 is an example diagram 1500 demonstrating the tightest PRNG for a reliant row-version R1V10 having a right committed neighbor row version is R1V11, for various cases, at the moment of inspection. As demonstrated in FIG. 15A, the middle PiTs are P2, P3, . . . , P7, which are covered by PINT2, PINT3 and PINT4. The earliest PiT and the latest PiT out of the middle PiTs are P2 and P7, respectively. PINT2 covers P2 and PINT4 covers P7. Therefore, the tightest PRNG for R1V10 is PR (PINT2, PINT4). It should be noted that in this example, R1V10 is not covered by PINT2 (R1V10 is to the left of PINT2), and R1V11 is not covered by PINT4 (R1V11 is to the right of PINT4).

As demonstrated in FIG. 15B, the same analysis as in FIG. 15A leads to the conclusion that the tightest PRNG for R1V10 is PR (PINT2, PINT4). In this example, R1V10 and R1V11 are covered by PINT2 and PINT4, respectively. As demonstrated in FIG. 15C, the middle PiTs are P3, P4, P5, and P6. The earliest PiT and latest PiT out of the middle PiTs are P3 and P6, respectively. PINT2 covers P3 and PINT4 covers P6. Therefore, the tightest PRNG for R1V10 is PR (PINT2, PINT4).

It should be noted that this example demonstrates how R1V10 and R1V11 may be located “in the middle” of the PINTs associated with the tightest PRNG for R1V10 (PINT2 and PINT4, respectively). PINT2 and PINT4 may cover more PiTs than R1V10 relies on. As such, R1V10 does not rely on P2 and P7. However, since PINT2 aggregates multiple PiTs, since PINT4 aggregates multiple PINTs, and since PR (PINT2, PINT4) is the tightest PRNG for R1V10, then R1V10 is determined as unneeded only after P2 and P7 (as well as P3, P4, P5, and P6) are removed.

In FIG. 15D, the middle PiTs are P4 and P5. PINT3 covers P4 and P5. Therefore, the tightest PRNG for R1V10 is PR (PINT3, PINT3). It should be noted that this example demonstrates how R1V10 and R1V11 may be covered by PINTs that are not covered by the tightest PRNG for R1V10.

In an embodiment, a reliant row-version can be added to a PRNG object based on a PRNG Expansion Principle. This principle defines that any PRNG that is broader than and that fully covers the tightest-fitting PRNG for a reliant row-version conforms to the PRNG fitness principle for the reliant row-version.

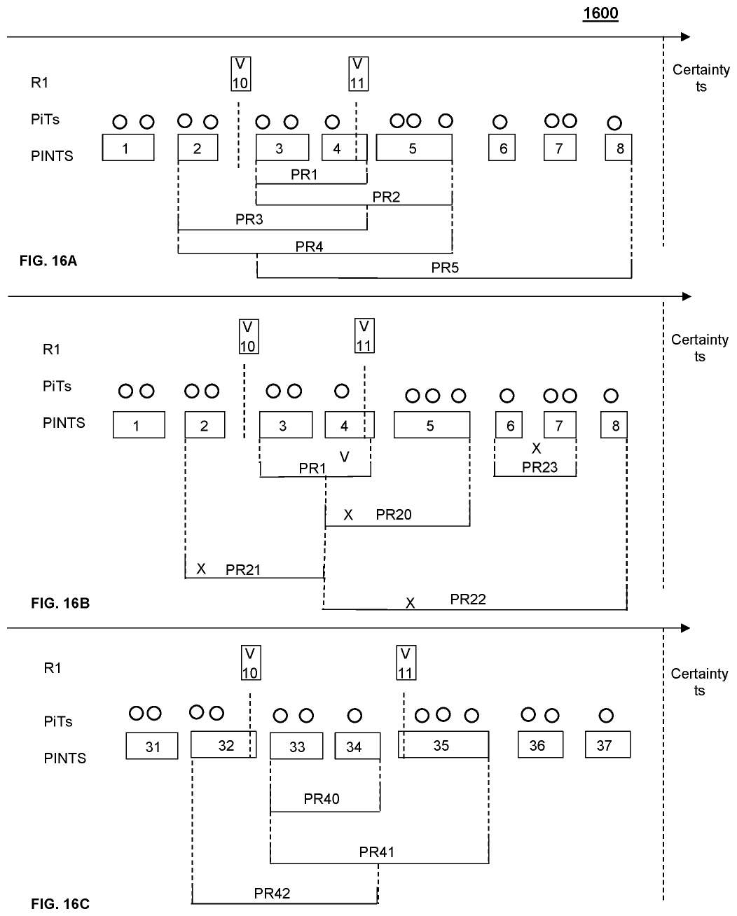

FIGS. 16A-16C show an example diagram 1600 demonstrating the PRNG expansion principle.

As demonstrated in FIG. 16A, PR1 (PINT3, PINT4) is the tightest PRNG for R1V10. All the other drawn PRNGs, e.g., PR2, PR3, PR4, and PR5, conform to the expansion principle as they all fully cover PR1. Those PRNGs conform to the expansion principle as well as to the fitness principle for R1V10.

As demonstrated in FIG. 16B, the same state as in FIG. 16A is presented. PR1 (PINT3, PINT4) is the tightest PRNG for R1V10. None of the other PRNGs drawn, namely PR20, PR21, PR22, and PR23, conform to the expansion principles as they do not fully cover PR1. In other words, they do not cover all the PINTs covered by PR1. None of the PRNGs PR20, PR21, PR22, and PR23 conform to the expansion principle as well as to the fitness principle for R1V10.

As demonstrated in FIG. 16C, a different configuration from that of FIGS. 16A and 16B, PR40 (PINT33, PINT34) is the tightest PRNG for R1V10, even though R1V10 is covered by PINT32 and R1V11 is covered by PINT35. The other drawn PRNGs, namely PR41 and PR42, conform to the expansion principle as well as the fitness principle for R1V10.

In most cases, the selection of the tightest PRNG to add a reliant row-version would provide optimal performance. However, there may be other considerations that may lead to a choice of a broader PRNG. As a non-limiting example, if a mechanism attempts to limit the number of existing PRNG objects and if choosing the tightest PRNG for a reliant row-version would mean that a new PRNG object would be created, the implementation may choose a broader yet existing PRNG object for the reliant row-version.

In IBC-technique, PRNG objects are organized in PRNG collections. A PRNG Collection PRC1 (PINT1) contains all the PRNG objects having leftmost (earliest) PINT is PINT1. In other words, if a PRNG object PR1 is associated with a PINT range [PINT1, PINTx], then it is associated with the PRNG collection PRC1 (PINT1). There is exactly one PRNG collection for a given PINT PINT1. When PINT1 is created, its PRNG collection is created.

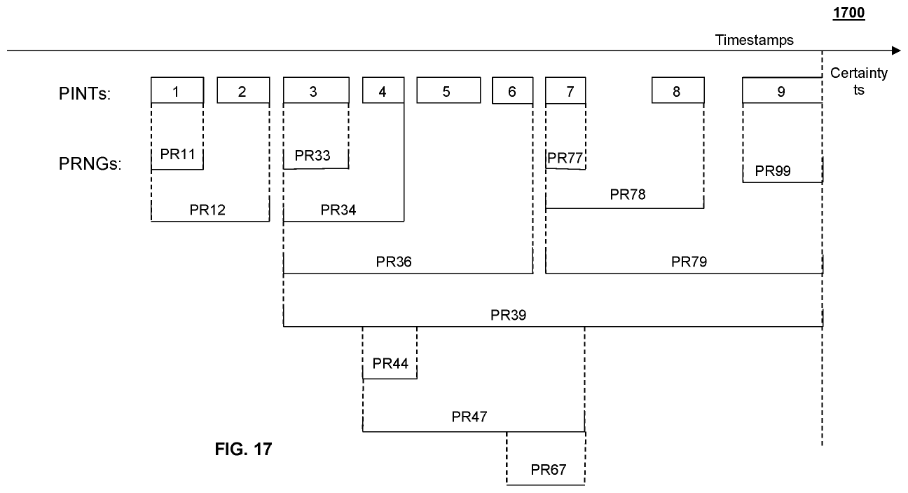

FIG. 17 illustrates an example diagram 1700 where there are 9 PINTs (PINT1, . . . , PINT9) and many PRNG objects. Those PRNG objects belong to PRNG collections in the following way:
PRC1 (PINT1)={PR11, PR12}
PRC2 (PINT2)={ }
PRC3 (PINT3)={PR33, PR34, PR36, PR39}
PRC4 (PINT4)={PR44, PR47}
PRC5 (PINT5)={ }
PRC6 (PINT6)={PR67}
PRC7 (PINT7)={PR77, PR78, PR79}
PRC8 (PINT8)={ }
PRC9 (PINT9)={PR99}

It should be noted that some of the PRNG collections (PRC2, PRC5, and PRC8) are empty, as there are no reliant row-versions associated with PRNG objects whose leftmost PINT is PINT2, PINT5, or PINT8, respectively.

In an embodiment, a PRNG collection is realized as a persistent page-oriented data-structure. However, it should be noted that the IBC-technique is compatible with any other data-structure implementation for the PRNG collection, that may or may not be a persistent or page-oriented data-structure.

A PRNG collection includes or maintains zero, one or more PRNG objects. Each PRNG object contains a PRNG Right Timestamp and a Reliant Row-Version Set Anchor. The PRNG Right Timestamp identifies the PRNG object and the Reliant Row-Version Set Anchor contains all the reliant row-versions associated with the PRNG object.

A PRNG object is generally identified by its leftmost and rightmost PINTs. The leftmost PINT is inherently identified by the PRNG collection containing the PRNG object, as the PRNG collection contains only the PRNG objects whose leftmost PINT is the PINT associated with the PRNG collection. Therefore, in order to identify a PRNG object within a specific PRNG collection, only its rightmost PINT needs to be specified.

In an embodiment, a PRNG object is associated with its rightmost PINT by the PRNG object's PRNG Right Timestamp. This technique supports an implicit change of the PRNG object's association with its rightmost PINT. For example, if PINT15 is the rightmost PINT of a PRNG object PR10 (PINT10, PINT15) and PINT14 is the left neighbor PINT of PINT15 that is covered by PR10, then the removal of PINT15 will “automatically” or implicitly change its PINT range association to the newer range (PINT10, PINT14), without needing to change PR10's PRNG right timestamp. In this example, maintaining the same PRNG right timestamp would allow for the deduction that PR10's rightmost PINT is now PINT14.

Following the creation of a PRNG object PR10, if the rightmost PINT of PR10 is PINT20, then PR10's PRNG right timestamp (denoted as PRT10 for brevity) is assigned to a timestamp that is covered by PINT20.

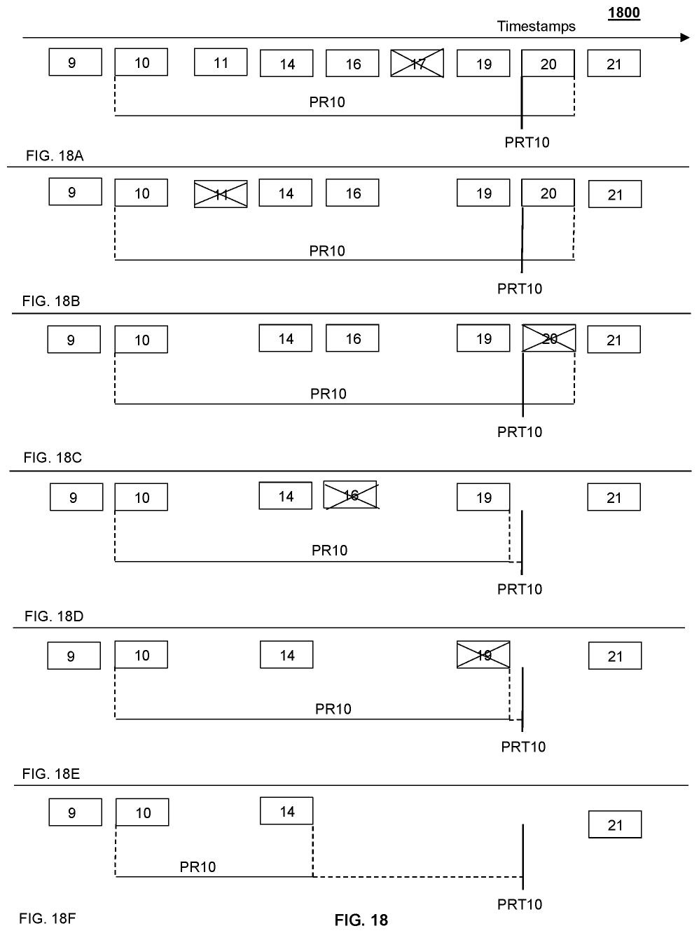

In an embodiment, when PR10's rightmost PINT needs to be deduced, or “resolved”, the procedure includes the following steps. First, the PINT collection structure is queried to identify the PINT that currently covers PRT10, if any exist. If such a PINT exists, that PINT is returned, and the procedure ends. If such a PINT does not exist, the latest (rightmost) PINT that ends earlier than (is to the left of) PRT10 is found and returned, and the procedure ends. The following procedure is discussed with reference to FIG. 18.

It should be noted that the procedure to resolve a PRNG object's rightmost PINT will always result in a PINT, and that the PINT will not be earlier than the PRNG object's leftmost PINT (PINT10). The reason for this characteristic is that, at the moment that the procedure commences, PINT10 must exist as a precondition for the existence of PR10.

As long as a PINT PINT20 is not removed or converged with another PINT, a PRNG object PR10 associated with the range (PINT10, PINT20) will return PINT20 when a resolution procedure is applied to PR10.

If PINT20 becomes PiT-empty and, as a result, is removed, then the PRNG object PR10 will be associated with the range (PINT10, PINTx), where PINTx is the PINT “to the left” of the removed PINT20. It should be noted that this process of re-association can continue further if the left neighboring PINTs also become PiT-empty and are removed. It should be further noted that the process of re-association would stop once the rightmost PINT of PR10 is PINT10, since PR10 would not exist if PINT10 were to be removed.

FIGS. 18A through 18F are example diagrams demonstrating the above resolution procedure.

At FIG. 18A, PRNG PR10 is created. PR10's rightmost PINT is PINT20. PRT10 is set to timestamp ts20 that is the start timestamp of PINT20. PRT10 is not changed later. After PRT10 is set to ts20, PINT17 is removed.

At FIG. 18B, the removal of PINT17 did not change anything regarding PR10, which remains as (PINT10, PINT20). Then, PINT11 is removed.

At FIG. 18C, the removal of PINT11 did not change anything regarding PR10, which remains as (PINT10, PINT20). Then, PINT20 is removed.

At FIG. 18D, since PINT20 was removed, PR10 is implicitly changed to be (PINT10, PINT19). The change conforms to the resolution procedure, as PINT19 is “to the left” of ts20. Then, PINT16 is removed.

At FIG. 18E, the removal of PINT16 did not change anything regarding PR10, which remains as (PINT10, PINT19). Then, PINT19 is removed.

At FIG. 18F, since PINT19 was removed, PR10 is implicitly changed to be (PINT10, PINT14). The change conforms to the resolution procedure, as PINT14 is “to the left” of ts20.

In the example scenario demonstrated by FIGS. 18A through 18F, if PINT20 was converged with another PINT PINT21, then the resulting PINT21 would “fully cover” PINT20, and would have an expanded scope that would be extended either “to the right” of PINT20, “to the left” of PINT20, or “to both directions”. In all those cases, the converged PINT21 would still cover PRT10. Therefore, the resolution procedure would detect PINT21 as PR10's rightmost PINT, as expected. This process of re-association may also continue in induction for further expansions as well as for PINT removals.

It should be noted that the N-level PINT strategy will result in a PINT convergence such that PINT21 will never extend “to the right” of PINT20. In that respect, the explanation above covers cases that are not covered by the N-level PINT strategy. However, there may be variations of the N-level PINT strategy, as well as other PINT strategies, that may involve such a case, and the resolution procedure will not undermine correctness for such cases.

It should be noted that there may be other timestamp values that may be assigned to PRT10 and still maintain correctness, other than the timestamps covered by PINT20. For example, a timestamp may be chosen that is later than PINT20 and still earlier than PINT20's right neighbor. Although such a decision may not have any real advantage, the present disclosure is compatible with such an approach.

In an embodiment, an alternative approach for using the PRNG right timestamp may be to use a value that is associated with the RTINT that corresponds to the PRNG object's rightmost PINT. For example, when creating PR10 the details of the RTINT RTINT20 that is associated with PINT20 may be stored.

In an example embodiment, the following operations can be performed on a PRNG collection data-structure. Such operations may include the following:

The PRNG objects contained by the PRNG collection may be scanned in an order corresponding to their PRNG right timestamp. According to this operation, the PRNG objects would be sorted by their right timestamps in an ascending order.

A PRNG object may be inserted “to the right”. According to this operation, a PRNG object that has a higher PRNG right timestamp than any of the existing PRNG objects contained by the PRNG collection may be inserted into the PRNG collection.

A PRNG object may be inserted “almost to the right”. It may be desirable to be able to insert a PRNG object that has a PRNG right timestamp among the highest right timestamps of the existing PRNG objects of the PRNG collection in a reasonably efficient manner. The intention of this operation is to be able to insert a PRNG object even if its PRNG right timestamp is lower than that of the highest PRNG in that PRNG collection.

In an example embodiment, a PRNG collection data-structure can be realized as a persistent tree, such as a B+Tree. Furthermore, a single persistent tree, such as a B+Tree may be used for the entire set of existing PRNG collections, which may be keyed by the tuple (left_PINT, PRNG right timestamp). The persistent tree may be combined with the structure of the PINT collection.

In another embodiment, PRNG collection data-structure is implemented as a singly linked list of pages, where each page contains an array of PRNG objects. In yet another embodiment, a doubly linked list may be used as the data-structure. The PRNG objects are stored and sorted by their PRNG right timestamp within each page and across the pages. As PRNG objects are generally not removed, and are generally added “to the right”, the linked list of pages generally grows by adding PRNG objects to the rightmost page and when that page overflows, by adding another page “to the right” to the existing page list. It should be noted that the IBC-technique disclosed herein is compatible with these data-structures.

In an embodiment, a reliant row-version set (RRVS) is a structure that contains all the reliant row-versions that were added to a pertinent PRNG object. At any given moment, each reliant row-version belongs to exactly one reliant row-version set. A reliant row-version set is an unordered collection. In other words, the order of its contained row-versions is not important.

In an embodiment, a reliant row-version set is realized as a persistent page-oriented structure. However, the disclosed IBC-technique is compatible with any other data structure implementation for the reliant row-version sets, which may or may not be a persistent and/or a page-oriented data-structure.

In the disclosed embodiments, the reliant row-version set data-structure may be implemented as a linked list of pages, where each page can contain a set of row-version IDs. The reliant row-version set data-structure includes an anchor as well as zero, one or more pages. An anchor is located as part of the pertinent PRNG object. In one implementation, the anchor includes a pointer to the first page (or NULL if the list is empty), as well as a pointer to the last page (or NULL if the list is empty). A page includes at least:
next_page point: this is a pointer for the next page in the page list, if one exists, or NULL if such a next page does not exist (i.e., the current page is the last page in the page list).
num_of_row_version_ids field: this field designates a number of row-version IDs currently contained by the page.
row_version_ids [N] array: this is an array of N row-version IDs where N is the largest number of row-version IDs that can be contained by the remaining part of the page.

In an embodiment, when a reliant row-version set RRVS1 is first initialized, its anchor is initialized and RRVS1 contains no pages. As will be discussed below, a reliant row-version RV1 is added to a reliant row-version set during an inspection of a row-version. The following is the procedure for adding a new reliant row-version to an RRVS. The process will be discussed with reference to an example where a reliant row-version RV1 is added to a reliant row-version set RRVS1.

The procedure first checks if there is a need to allocate a new page to RRVS1. There may be such a need in two cases: when the page-list is empty or when the first page is full. In those cases, a new page is allocated, initialized, and made as the new first page.

In an embodiment, when a page-list is empty, a new page P1 is allocated, and the page's properties are set as follows:
P1's next_page is set to NULL.
P1's num_of_row_version_ids is set to 0.
The anchor's first_page is set to P1.
The anchor's last_page is set to P1

In another embodiment, when a current first page, for example, P10 is full, a new page P11 is allocated the following properties:
P11's next_page is set to P10.
P11's num_of_row_version_ids is set to 0.
The anchor's first_page is set to P11

Then, an ID of a reliant row-version RV1 is added to the page, which may either be new or current. In an embodiment where such a page is the page P20, the properties or P20 are set as follows:
P20's row_version_ids [num_of_row_version_ids] is set to RV1's ID
P20's num_of_row_version_ids is incremented

In some instances, there is a need to merge multiple reliant row-version sets to save on computer resources. There are a number of merge operations, which may include 2-to-1 merges, many-to-many merges, where those could be done in ways that tightly maintain the non-sparseness of the merged list, or in ways that may result in sparser merged list. A reliant row-version set is an unordered collection, and therefore, there is no need to preserve any order during a merge or as the result of a merge.

According to the disclosed embodiments, upon a PiT removal, it may be determined that a PRNG object's reliant row-versions became unneeded. A cleaning process for the row-versions of RRVS1 then takes place. During that cleaning process, all the row-version IDs in RRVS1 are read. Once a row-version ID is read from RRVS1, it is no longer needed, and can be removed from RRVS1 (desirably in an efficient manner). Eventually, RRVS1 is removed.

Reading the row-version IDs of RRVS1 can be performed by traversing the page-list in a respective RRVS, and, in each page, traversing the contained row-version IDs. Once a row-version RV1 is read, it can be removed. In one embodiment, a row-version ID can be removed one by one. In another embodiment, each page of RRVS1 can be released once its row-version ID traversal is completed. In yet another embodiment, the release of the RRVS1's pages can take place once the entire traversal of RRVS1 is completed.

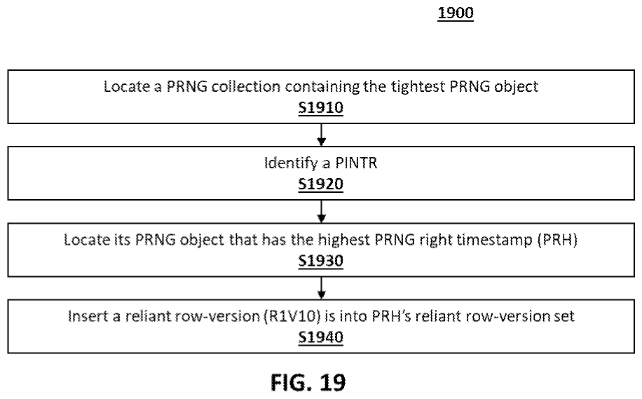

FIG. 19 shows an example flowchart 1900 of a procedure for identifying PINTs and locating the pertinent PRNG collection to add classified reliant row-versions according to an embodiment. As described above, when a row-version is classified as reliant, it is added to the relevant cleaner structures. Specifically, in an embodiment, first, the tightest PRNG object is located for a reliant row-version (e.g., R1V10). As already discussed, at the moment of inspection, since R1V10 is classified as reliant, it is guaranteed that it has a right committed neighbor row-version (e.g., R1V11), and it is guaranteed that at that moment of inspection, there are “middle PiTs” (one or more) “in-between” R1V10 and R1V11. It should be noted that if such a PRNG object does not exist, or in some cases where locating such a PRNG object is more expensive, a different type of PRNG object may be selected, as long as that PRNG object conforms to the fitness principle for R1V10. For the sake of brevity, PINTL is defined as the PINT that contains the earliest PiT out of the middle PiTs (hereafter, “the earliest middle PiT”), and PINTR is defined as the PINT that contains the latest PiT out of the middle PiTs (hereafter, “the latest middle PiT”).

At S1910, a PRNG collection that would contain the tightest PRNG object, if exists, is located. As previously discussed, all the PRNG objects whose leftmost PINT is PINTL are located in the PRNG collection associated with PINTL. In an embodiment, S1910 includes deducting an identity of PINTL, locating the earliest middle PiT (“PiTL”), and locating the PINT containing PiTL.

In one embodiment, locating the earliest middle PIT (PiTL) includes checking in the existing PiT collection for the leftmost (i.e., earliest) PiT of the middle PiTs, or, in other words, the earliest PiT that is later than CMTS (R1V10). Furthermore, locating the PINT containing PiTL includes querying the PINT collection structure to identify the PINT containing PiTL, which is equivalent to identifying the PINT that covers TS (PiTL). The located PINT is PINTL.

For example, referring back to FIGS. 15A-15D that illustrate examples for locating a PRNG collection that contains the tightest PRNG object according to an embodiment. Within FIGS. 15A and 15B, P2 is identified as PiTL by checking the existing PiT collection. Then, PINT2 is identified as PINTL by querying the PINT collection to identify the PINT containing PiTL. Within FIG. 15C, P3 is identified as PiTL. Then, PINT2 is identified as PINTL. Within FIG. 15D, P4 is identified as PiTL. Then, PINT3 is identified as PINTL.

At S1920, a PINTR is identified. This includes locating the latest middle PiT (PiTR) and locating the PINT containing PiTR. In an embodiment, locating the PiTR includes checking in the existing PiT collection for the rightmost (i.e., latest) PiT of the middle PiTs, or, in other words, the latest PiT that is earlier than CMTS (R1V11). Furthermore, locating the PINT containing PiTR includes querying the PINT collection structure to identify the PINT containing PiTR, which is equivalent to identifying the PINT that covers TS (PiTR). The located PINT is denoted as PINTR.

FIGS. 15A-15D illustrate some examples showing the identification of PINTR according to the embodiment. Within FIGS. 15A and 15B, P7 is identified as PiTR by checking the existing PiT collection. Then, PINT4 is identified as PINTR by querying the PINT collection to identify the PINT containing PiTR. Within FIG. 15C, P6 is identified as PiTR. Then, PINT4 is identified as PINTR. It should be noted that the difference between this scenario and the scenario in FIG. 15B is that PiTR within FIG. 15C is not the rightmost PiT of PINT4, and yet, PINT4 is identified as PINTR. Within FIG. 15D, P5 is identified as PiTR. Then, PINT3 is identified as PINTR.

At S1930, the PRNG objects of the PRNG collection associated with PINTL (PRCL) are scanned to locate the PRNG object that has the highest PRNG right timestamp (PRH). In an embodiment, S1930 includes accessing the last page of the PRCL (if such exist), and, within that page, accessing the last PRNG object. That is essentially the PRNG of the PRCL with the highest PRNG right timestamp. Such an access may be more efficient than scanning all the PRNG objects of PRCL. The rightmost PINT of PRH (PINTH) is concluded using PRH's PRNG Right Timestamp. It should be noted that the procedure for concluding the rightmost PINT of PRH given PRH's Right Timestamp is discussed above.

At S1940, a reliant row-version (R1V10) is inserted into PRH's reliant row-version set. Then, the procedure ends.

There are a number of embodiments determining the insertion of a reliant row-version in the PRH's reliant row-version set. In one embodiment, when PINTH=PINTR, then PRH is the tightest PRNG object for R1V10. Here, the reliant row-version (R1V10) is then inserted into PRH's reliant row-version set, and the procedure ends.

In another embodiment, when PINTH<PINTR (i.e., PINTH is earlier than PINTR), then PRH is “too narrow” to contain R1V10. Here, a new PRNG object PRNEW (PINTL, PINTR) is added to the end of PRCL and then R1V10 is inserted into PRNEW's reliant row-version set. If PRH does not exist, i.e., PRCL contains no PRNG objects, a new PRNG object PRNEW (PINTL, PINTR) is added to the end of PRCL and then R1V10 is inserted into PRNEW's reliant row-version set.

In yet another embodiment, when e PINTH>PINTR (i.e., PINTH is later than PINTR), then PRH is “broader” than the tightest PRNG for R1V10. It should be noted that PRH conforms to the expansion principle as well as to the fitness principle for R1V10. In this embodiment, R1V10 is inserted into PRH.

In yet another embodiment, the tight PRNG object is searched within the entire PRCL, and if such PRNG object does not exist, then a PRGN object is created and added PRCL in the right location within PRCL. Then, R1V10 is inserted into its reliant row-version set. The search may be restricted for the tight PRNG object only to the last page of PRCL that was already loaded to RAM by previous steps. If that PRNG object is found, then R1V10 is inserted into its reliant row-version set. If that PRNG object is not found, then a broader PRNG object can be used instead, similarly to the description made above. Alternatively, the tight PRNG object can be added, if conditions allow.

It should be noted that comparison between rightmost PINTs, i.e., whether one PRNG object's rightmost PINT is earlier, later, or equal to another PRNG object's rightmost PINT—can be efficiently achieved in ways such as querying the PINT collection, possibly aided by resolving rightmost PINTs from the PRNG Objects' PRNG Right Timestamp. It should be noted that there are additional techniques to select and/or create an appropriate PRNG object with a reliant row-version set to which R1V10 will be inserted, where the PRNG object selected should conform to the fitness principle. Such techniques are compatible with the disclosed embodiments.

As noted above, when a PiT-removal event notification causes a PINT to be PiT-empty, the PINT is typically removed. In an embodiment, the PINT removal may be deferred. For example, the removal of a PiT-empty open-ended PINT is deferred until it is no longer an open-ended one. The PINT removal will take place then, as long as it is PiT-empty at that moment.

Generally, multiple PRNG objects that are effectively associated with the same PINT range can happen as a result of implicit changes in the PINT range with which a PRNG object is associated.

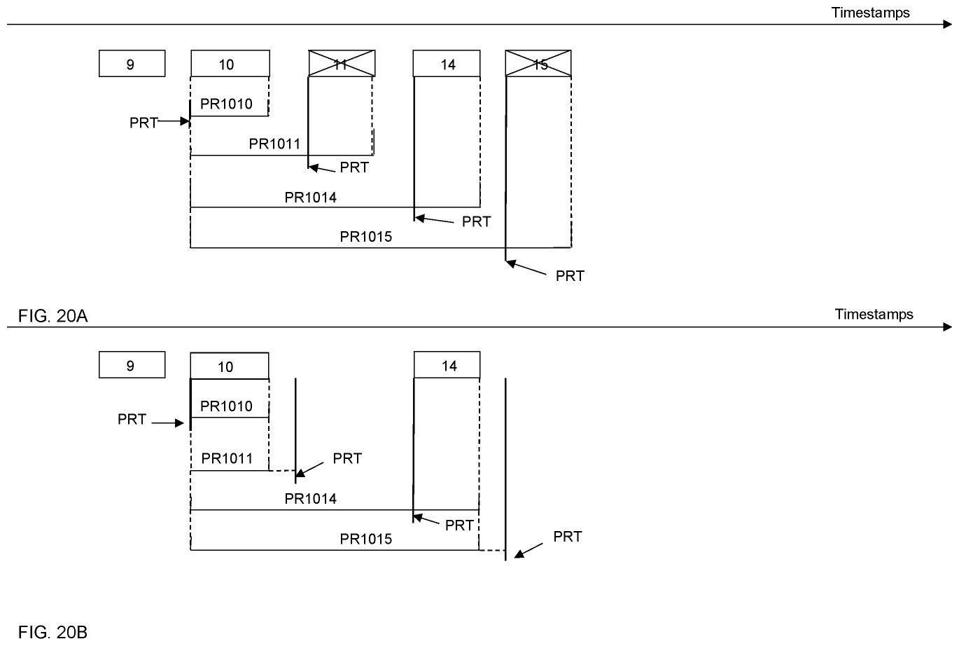

FIG. 20A shows a configuration where 5 PINTs are shown: PINT9, PINT10, PINT11, PINT14, and PINT15. In addition, four PRNG objects are shown: PR1010, PR1011, PR1014, and PR1015, where those four PRNG objects constitute the PRNG collection PRC10 that is associated with PINT10. Then, as shown in FIG. 20A, PINT11 and PINT15 are removed.

FIG. 20B shows the state after both PINT11 and PINT15 were removed. As a result, PR1011 was implicitly modified, and it now covers PINT10 only (while its PRNG right timestamp was not changed as the change was implicit). Similarly, PR1015 was implicitly modified, and it now covers the range (PINT10, PINT14). As a result, both PR1010 and PR1011 cover the same PINT range (PINT10, PINT10) that contains a single PINT (PINT10). In addition, both PR1014 and PR1015 cover the same PINT range (PINT10, PINT14).

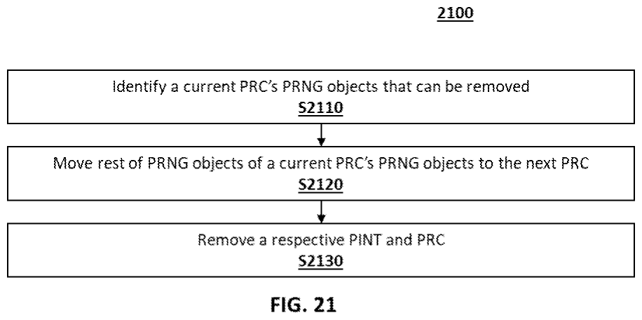

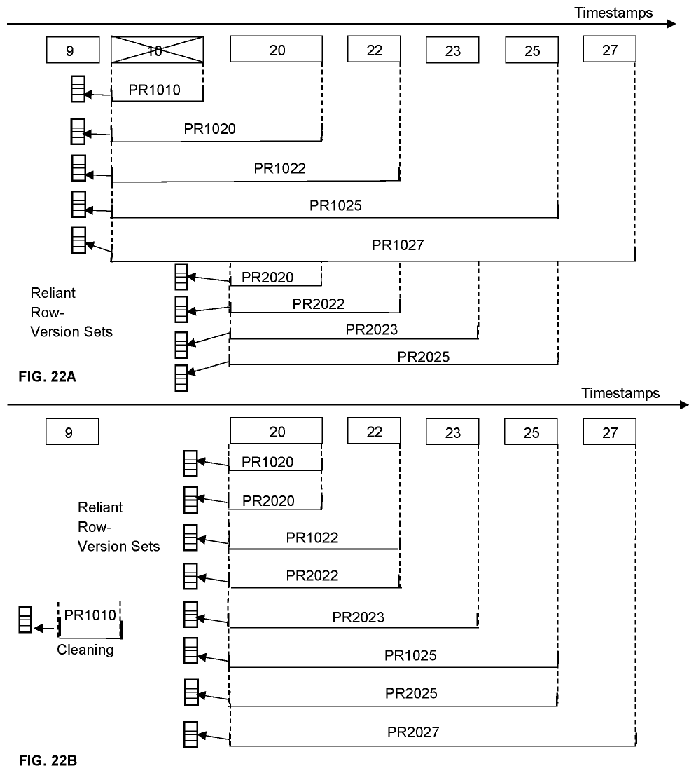

FIG. 21 shows an example flowchart 2100 for removing a PINT according to an embodiment. The flowchart will be discussed with reference to a specific example of removing PINT10 having a PRNG collection PRC10 shown in FIGS. 22A and 22B.

At S2110, PRC10's PRNG objects that can be removed (that is, those whose contained reliant row-versions can be sent to be cleaned) are identified.

At this stage, PRC10's PRNG objects that cover PINT10 only, if any exist, are detected, and their reliant row-version sets are sent for cleaning. In an embodiment, S2110 includes identifying and accessing PRC10. This can be performed by accessing the PINT collection structure. S2110 also includes scanning PRC10's PRNG objects according to their PRNG right timestamp.

At S2120, the rest of the objects of a current PRNG collection (PRC), for example, PRC10's PRNG objects, are moved to the next PRNG collection (e.g., PRC20), that is the PRNG collection of the right neighbor PINT.

At this stage, the remaining PRC10's PRNG objects are moved to the PRNG collection of PINT20, that is denoted as PRC20, as PINT20 is the right neighbor of PINT10. As part of that movement, those PRNG objects are assigned with their leftmost PINT modified from PINT10 to PINT20. As a result, such a moved PRNG object may become equivalent to another PRNG object that already resides in PRC20. Two PRNG objects that essentially cover the same PINT range are denoted as Equivalent PRNG Objects. As part of that movement, equivalent PRNG objects are optionally merged into one, by merging their reliant row-version sets.

In an embodiment, S2120 can be performed without merging equivalent PRNG Objects. FIG. 22A demonstrates the result of such an operation. FIG. 22A shows two PRNG collections: PRC10 that is associated with PINT10, containing 5 PRNG objects, and PRC20 that is associated with PINT20, containing 4 PRNG objects. PINT10 is then removed. FIG. 22B shows the result of the procedure described so far. Note that, as shown, the reliant row-versions of PR1010 are sent for cleaning, and eventually PR1010 is removed. In addition, PRC20 now contains 8 PRNG objects, some of which are equivalent. For example, PR1022 and PR2022 are equivalent to each other.

In another embodiment, S2120 can be performed with merging of (all or some) equivalent PRNG objects. That is, during a merge-sort operation, two or more equivalent PRNG objects are merged into one and that merged PRNG object is added into the merge-sorted result. Note that merging of two equivalent PRNG objects involves merging their two reliant row-version sets. The topic of merging reliant row-version sets was discussed previously.

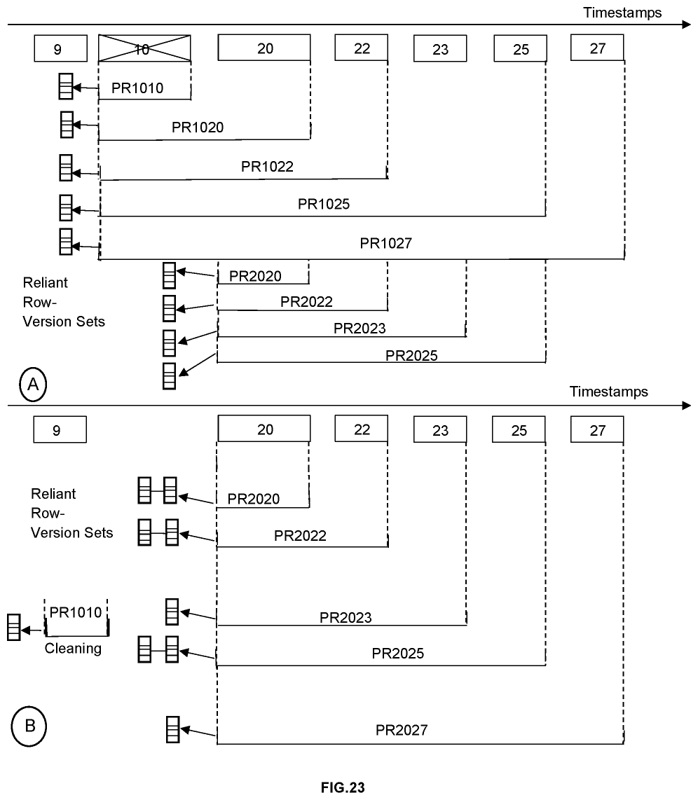

FIGS. 23A-23B demonstrate the result of such an operation. FIG. 23A shows two PRNG collections: PRC10 that is associated with PINT10, containing 5 PRNG objects, and PRC20 that is associated with PINT20, containing 4 PRNG objects. PINT10 is then removed (identical to the state shown in FIG. 22A). FIG. 23B shows the result of the procedure described so far, but with a merge-sort operation that merges equivalent PRNG objects. Note that, as shown, PR1010 is sent for cleaning, and PRC20 now contains 5 PRNG objects that are not equivalent to each other. PR2020, PR2022, and PR2025 contain reliant row-version sets that were merged (with the corresponding row-version sets of PR1020, PR1022, and PR1025). PR2023 remained the same. PR1027 was moved from PRC10, and its leftmost PINT was modified to PINT20.

At S2130, the respective PINT and its PRNG collection are removed. That is, in the example herein, S2130 includes the removal of PINT10 and PRC10. Specifically, all the remaining resources that are not needed of PRC10 any more are removed, thus effectively removing PRC10. Then, all the resources related to PINT10, e.g., its information in the PINT collection may be removed. In addition, if an RTINT points to PINT10, it may need to be updated with the information that PINT10 was removed. In addition, any PRNG object whose reliant row-versions were sent for cleaning is eventually released as well. In the above example, PR1010 is such a PRNG object.

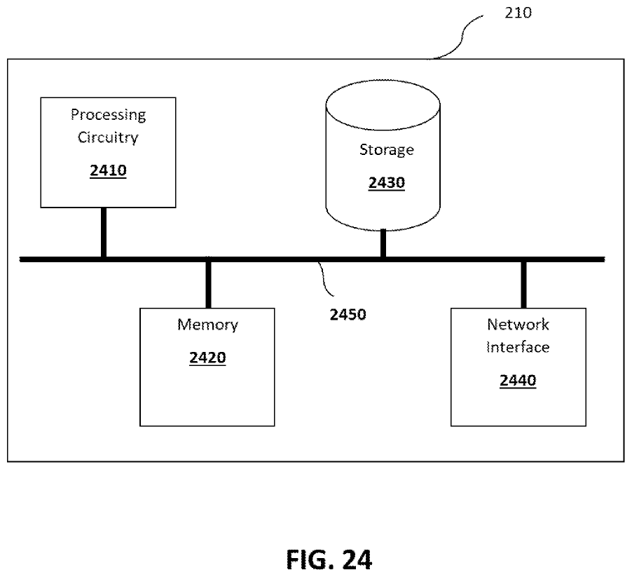

FIG. 24 is an example schematic diagram of a hardware layer of a node 210 in a database 120 according to an embodiment. The node 210 includes a processing circuitry 2410 coupled to a memory 2420, a storage 2430, and a network interface 2440. In an embodiment, the components of the node 210 may be communicatively connected via a bus 2450.

The processing circuitry 2410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 2420 may be volatile (e.g., random access memory, etc.), non-volatile (e.g., read-only memory, flash memory, etc.), or a combination thereof.

In one configuration, software for implementing one or more embodiments disclosed herein may be stored in the storage 2430. In another configuration, the memory 2420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 2410, cause the processing circuitry 2410 to perform the various processes described herein.

The storage 2430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 2440 allows the node to communicate with, for example, other nodes or with a transaction manager. It should be understood that the embodiments described herein are not limited to the specific architecture illustrated in FIG. 24, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), memory, and input/output interfaces. The computer platform may also include an operating system and microinstruction code. The various processes and functions described herein may be either part of the microinstruction code or part of the application program, or any combination thereof, which may be executed by a CPU, whether such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to further the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone, B alone; C alone; A and B in combination; B and C in combination; A and C in combination; or A, B, and C in combination.

What is claimed is:

1. A method for cleaning unneeded row-versions in a database system, comprising:
selecting eligible row-versions for inspection;
inspecting the selected row-versions, wherein the inspection results in a classification of eligible row-versions as unneeded or reliant;
marking row-versions classified as unneeded as approved for immediate removal;
adding row-versions classified as reliant to cleaner structures; and
upon detection of removal of all point-in-times (PiTs) related to a reliant row-version, deleting the reliant row-version, wherein the detection is performed by monitoring the cleaner structures.

2. The method of claim 1, wherein an unneeded row-version is at least a first committed row-version with a row having a second committed row-version and not PiT between the first and second committed row-versions, wherein the second committed row-version has been committed after the first committed row-version.

3. The method of claim 2, further comprising:
classifying a row-version as unneeded in relation to an inspected row-version.

4. The method of claim 1, wherein a reliant row-version is at least a first committed row-version with a row having a second committed row-version and at least one PiT between the first and second committed row-versions, wherein the second committed row-version has been committed after the first committed row-version.

5. The method of claim 4, further comprising:
classifying a row-version as reliant when there is at least one PiT in-between a classified row-version and an inspected row-version at the moment of inspection.

6. The method of claim 2, further comprising:
deleting unneeded row-versions marked as approved for immediate removal.

7. The method of claim 1, wherein inspecting the selected row-versions further comprises:
locating a left-committed neighbor row-version of a selected row-version (R_{K}V_{N}) belonging to a row (R_{K});
marking the located left-committed neighbor row-version as classified, when the located left-committed neighbor is marked as inspected and unclassified;
querying existing PiT collection to detect at least one PiT in-between the located left-committed neighbor row-version and the selected row-version (R_{K}V_{N});
labeling the located left-committed neighbor row-version as reliant, when at least one in-between PiT is detected;
labeling the located left-committed neighbor row-version as unneeded, when at least one in-between PiT is not detected; and
marking the selected row-version (R_{K}V_{N}) as inspected.

8. The method of claim 7, further comprising:
locating a right-committed neighbor row-version of a selected row-version (R_{K}V_{N}) belonging to the row (R_{K});
marking the selected row-version (R_{K}V_{N}) as classified, when the located right-committed row-version's committed timestamp is earlier than a certainty timestamp;
querying existing PiT collection to detect at least one PiT in-between the located right-committed neighbor row-version and the selected row-version (R_{K}V_{N});
labeling the selected row-version (R_{K}V_{N}) as reliant, when at least one in-between PiT is detected;
labeling the selected row-version (R_{K}V_{N}) as unneeded, when at least one in-between PiT is not detected; and
marking the selected row-version (R_{K}V_{N}) as inspected.

9. The method of claim 1, wherein the cleaner structures include: PIT Intervals (PINTs), PINT collections, PINT Ranges (PRNGs), PRNG Collections, and reliant row-version sets.

10. The method of claim 9, wherein a PINT is an interval of timestamps [x, y] containing all the PiTs with timestamps that are between x and y, where x is earlier than y.

11. The method of claim 10, wherein a PINT collection is as a set of non-overlapping PINTs that include PiTs that currently exist up to a current certainty timestamp.

12. The method of claim 10, wherein a PRNG includes PINTs covering timestamps in a given range of the PRNG, wherein a PRNG is realized as an object, and wherein a PRNG object can be created or removed.

13. The method of claim 12, wherein a reliant row-version set contains reliant row-versions that were added to a PRNG object at any given moment, wherein each reliant row-version belongs to exactly one reliant row-version set.

14. The method of claim 12, wherein removing the reliant row-version further comprises:
deleting a reliant row-version included in a reliant row-version set associated with a specific PRNG, when all PiTs within PINTs covered by the specific PRNG are removed.

15. The method of claim 1, wherein the database system is a distributed database including a plurality of nodes.

16. The method of claim 1, wherein the database system is a non-distributed database.

17. A device for cleaning unneeded row-versions in a database system comprising:
one or more processors configured to:
select eligible row-versions for inspection;
inspect the selected row-versions, wherein the inspection results in a classification of eligible row-versions as unneeded or reliant;
mark row-versions classified as unneeded as approved for immediate removal;
add row-versions classified as reliant to cleaner structures; and
upon detection of removal of all point-in-times (PiTs) related to a reliant row-version, delete the reliant row-version, wherein the detection is performed by monitoring the cleaner structures.

18. The device of claim 17, wherein an unneeded row-version is at least a first committed row-version with a row having a second committed row-version and not PiT between the first and second committed row-versions, the second committed row-version has been committed after the first committed row-version.

19. The device of claim 18, wherein the one or more processors are further configured to:
classify a row-version as unneeded in relation to an inspected row-version.

20. The device of claim 18, wherein the one or more processors are further configured to:
delete unneeded row-versions marked as approved for immediate removal.

21. The device of claim 17, wherein a reliant row-version is at least a first committed row-version with a row having a second committed row-version and at least one PiT between the first and second committed row-versions, the second committed row-version has been committed after the first committed row-version.

22. The device of claim 21, wherein the one or more processors are further configured to:
classify a row-version as reliant when there is at least one PiT in-between a classified row-version and an inspected row-version at the moment of inspection.

23. The device of claim 17, wherein the one or more processors, when inspecting the selected row-versions, are configured to:
locate a left-committed neighbor row-version of a selected row-version (RKVN) belonging to a row (RK);
mark the located left-committed neighbor row-version as classified, when the located left-committed neighbor is marked as inspected and unclassified;
query scanning existing PiT collection to detect at least one PiT in-between the located left-committed neighbor row-version and the selected row-version (RKVN);
label the located left-committed neighbor row-version as reliant, when the at least one in-between PiT is detected;
label the located left-committed neighbor row-version as unneeded, when the at least one in-between PiT is not detected; and
mark the selected row-version (RKVN) as inspected.

24. The device of claim 23, wherein the one or more processors are further configured to:
locate a right-committed neighbor row-version of a selected row-version (RKVN) belonging to the row (RK);
mark the selected row-version (RKVN) as classified, when the located right-committed row-version's committed timestamp is earlier than a certainty timestamp;
scan querying existing PiT collection to detect at least one PiT in-between the located right-committed neighbor row-version and the selected row-version (RKVN);
label the located right-committed neighbor selected row-version (RKVN) as reliant, when the at least one in-between PiT is detected;
label the located right-committed neighbor selected row-version (RKVN) as unneeded, when the at least one in-between PiT is not detected; and
mark the selected row-version (RKVN) as inspected.

25. The device of claim 17, wherein the cleaner structures include:
PiT Intervals (PINTs), PINT collections, PINT Ranges (PRNGs), PRNG Collections, and reliant row-version sets.

26. The device of claim 25, wherein a PINT is an interval of timestamps [x, y] containing all the PiTs with timestamps that are between x and y, where x is earlier than y.

27. The device of claim 26, wherein a PINT collection is as a set of non-overlapping PINTs that include PiTs that currently exist up to a current certainty timestamp.

28. The device of claim 26, wherein a PRNG includes PINTs covering timestamps in a given range of the PRNG, a PRNG is realized as an object, and a PRNG object can be created or removed.

29. The device of claim 28, wherein a reliant row-version set contains reliant row-versions that were added to a PRNG object at any given moment, each reliant row-version belongs to exactly one reliant row-version set.

30. The device of claim 28, wherein the one or more processors, when removing the reliant row-version, are configured to:
delete a reliant row-version included in a reliant row-version set associated with a specific PRNG, when all PiTs within PINTs covered by the specific PRNG are removed.

31. The device of claim 17, wherein the database system is a distributed database including a plurality of nodes.

32. The device of claim 17, wherein the database system is a non-distributed database.

33. A non-transitory computer-readable medium storing a set of instructions for cleaning unneeded row-versions in a database system, the set of instructions comprising:
one or more instructions that, when executed by one or more processors of a device, cause the device to:
select eligible row-versions for inspection;
inspect the selected row-versions, wherein the inspection results in a classification of eligible row-versions as unneeded or reliant;
mark row-versions classified as unneeded as approved for immediate removal;
add row-versions classified as reliant to cleaner structures; and
upon detection of removal of all point-in-times (PiTs) related to a reliant row-version, delete the reliant row-version, wherein the detection is performed by monitoring the cleaner structures.
